(19) United States
(12) Patent Application Publication
(10) Pub. No.: US 2006/0276651 A1
(43) Pub. Date: Dec. 7, 2006

(54) Metal complexes

(76) Inventors: Urs Lehmann, Basel (CH); Colin Morton, Basel (CH); Beat Schmidhalter, Bubendorf (CH); Jean-Luc Budry, Rossemaison (CN)

Correspondence Address: CIBA SPECIALTY CHEMICALS CORPORATION;PATENT DEPARTMENT, 540 WHITE PLAINS RD, P O BOX 2005, TARRYTOWN, NY, 10591-9005, US

(21) Appl. No.: 10/553,776

(22) PCT Filed: May 5, 2004
(86) PCT No.: PCT/EP04/50706

§ 371 Date: Oct. 20, 2005

(30) Foreign Application Priority Data
May 14, 2003 (EP) 03405336.3

(51) Int. Cl. C07F 15/06; C07F 15/04; C07F 15/02; C07F 1/08

(52) U.S. Cl. 546/2; 556/32

(57) ABSTRACT

The present invention relates to metal complexes of formula I, compositions comprising the metal complexes, to recording media comprising the metal complexes or compositions and to the use of the compositions in the production of optical recording media: wherein the substituent are, as defined in the description. Use of the metal complexes formula (I) in combination with oxonol dyes results, surprisingly, in a comparatively weak tendency of the oxonol dyes to aggregate in the solid state so that the absorption curve remains advantageously narrow event in the solid state, as a result of which recording media having high reflectivity as well as high sensitivity and good playback characteristics in the desired spectral range are made available.

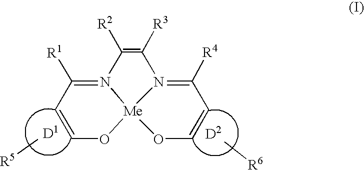

The present invention relates to metal complexes of formula (I), to recording media comprising the metal complexes and to the use of the metal complexes in the production of optical recording media. Use of the metal complexes of formula (I) In combination with, for example, oxonol dyes results, surprisingly, in a comparatively weak tendency of the oxonol dyes to aggregate in the solid state so that the absorption curve remains advantageously narrow even in the solid state, as a result of which recording media having high reflectivity as well as high sensitivity and good playback characteristics in the desired spectral region are made available.

Lacroix et al., describe in Chem. Mater. 8 (1996), 541 to 545 the synthesis and second order nonlinear optical properties of the following metal complexes:

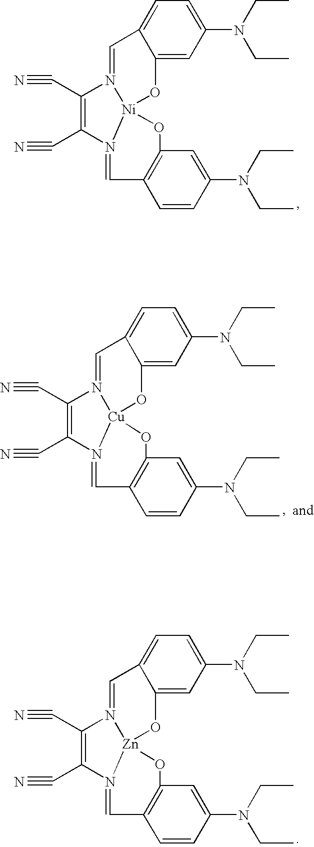

JP60-44390A discloses colorless metal complexes (stabilizer), which do not contribute to the refractive index at 658 nm.

WO03/042989, which forms state of the art according to Article 54(3) EPC, discloses compositions comprising at least one oxonol dye and at least one metal complex and recording media comprising the compositions. The following metal complex is explicitly mentioned in WO03/042989.

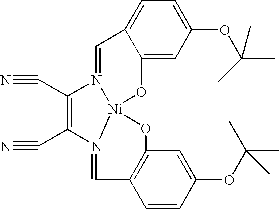

The present invention relates to metal complexes of the following formula 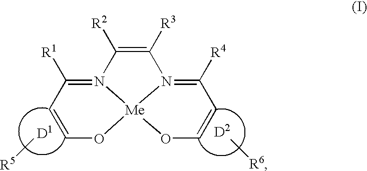
wherein

Me is a transition metal of Sub-Group 7, 8, 9, 10, 11 or 12, preferably 9, 10 or 11,

D¹ and D² are each independently of the other a carbocyclic or heterocylic ring or ring system, which may be unsubstituted or substituted by one or more groups R⁵ and R⁶,

R¹ and R⁴ are each independently of the other a hydrogen atom, a perfluoroalkyl radical, an unsubstituted or substituted alkyl radical, an aryl radical or an aralkyl radical,

R² and R³ are a cyano group, or

R² and R³ together form a five to seven membered heterocylic ring, or

R² and R³ together form an aromatic carbocyclic ring, which is substituted by at least one electron accepting substituent, or which is substituted by at least one electron donating substituent,

R⁵ and R⁶ being a halogen atom, such as fluorine, chlorine or bromine, a group —NR⁸R⁹, a group —SO₂NR⁸R⁹, wherein

R⁸ and R⁹are each independently of the other a hydrogen atom, an alkyl group, a C₁- C₂₄alkylcarbonyl group, an alkyl group which is substituted by E and/or interrupted by D, a C₈₋₂₄aryl-carbonyl radical or C₇₋₂₄aralkyl-carbonyl radical, an aryl group, or an aralkyl group, or R⁸ and R⁹together form a five- to seven-membered heterocylic ring, which optionally can be interrupted by D,

a nitro group, a cyano group, a hydroxy group, an alkyl group, an alkyl group which is substituted by E and/or interrupted by D, an alkoxy group which is substituted by E and/or interrupted by D, an aryloxy group, an aralkyloxy group, an alkylthio group which is substituted by E and/or interrupted by D, an arylthio group, an aralkylthio group, an acyl radical, a phenyl group, an ester group, such as a phosphonic acid, phosphoric acid or carboxylic acid ester group, a carboxamide group, a sulfamide group, an ammonium group, a carboxylic acid, sulfonic acid, phosphonic acid or phosphoric acid group or a salt thereof, wherein at least one of the substituents R⁵ and at least one of the substituents R⁸ is an electron donating group, if R² and R³ together form an aromatic carbocyclic ring, which is substituted by at least one electron accepting substituent, or at least one of the substituents R⁵ and at least one of the substituents R⁸ is an electron accepting group, if R² and R³ together form an aromatic carbocyclic ring, which is substituted by at least one electron donating substituent, wherein

D is —CO—; —S—; —SO—; —SO₂—; —O—; —NR¹⁰; and

E is —OR¹¹; —SR¹¹; —NR¹²R¹³; —COR¹⁴; —COOR¹⁵; —CONR¹²R¹³; —CN; or halogen; wherein

R¹⁰, R¹² and R¹³ are each independently of the other a hydrogen atom, an alkyl group, an aryl group, or an aralkyl group,

R¹¹ is a hydrogen atom, an alkyl group, an aryl group, or an aralkyl group,

R¹⁴ is an alkyl group, an aryl group, or an aralkyl group, and

R¹⁵ is a hydrogen atom, an alkyl group, an aryl group, or an aralkyl group, with the proviso that the following compounds are excluded:

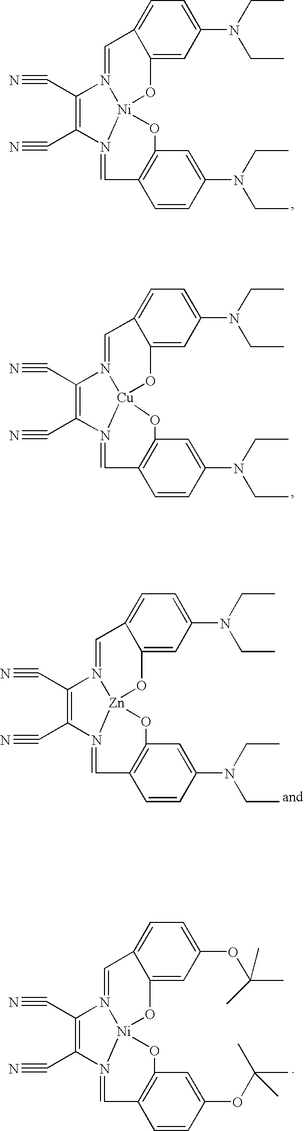

The use of the metal complexes of formula (I) in combination with, for example, oxonol dyes results, surprisingly, in a comparatively weak tendency of the oxonol dyes to aggregate in the solid state so that the absorption curve remains advantageously narrow even in the solid state, as a result of which recording media having high reflectivity as well as high sensitivity and good playback characteristics in the desired spectral ranged are made available. In addition, the metal complexes of formula (I) do not only function as stabilizer, but also as absorber, i.e. contribute to the refractive index at 658 nm.

In accordance with the invention, an alkyl radical is understood to be a straight-chain or branched C₁₋₂₄alkyl radical, preferably C₁₋₈alkyl radical, which may be unsubstituted or substituted, such as, for example, methyl, ethyl, n-propyl, isopropyl, n-butyl, sec-butyl, isobutyl, tert-butyl, cyclobutyl, n-pentyl, 2-pentyl, 3-pentyl, 2,2-dimethylpropyl, hexyl, heptyl, 2,4,4-trimethylpentyl, 2-ethylhexyl or octyl, ethoxycarbonylethyl, cyanoethyl, diethylamino-ethyl, chloroethyl, acetoxyethyl, and partially or fully halogenated C₁₋₈-alkyl radicals.

Examples of a halogen atom are fluorine, chlorine or bromine.

In accordance with the invention, a perfluoroalkyl radical is understood to be a straight-chain or branched C₁-C₂₄perfluoroalkyl, such as for example —CF₃, —CF₂CF₃, —CF₂CF₂CF₃ —CF(CF₃)_{2,} —(CF₂)₃CF₃, and —C(CF₃)₃.

In accordance with the invention, an alkoxy radical is understood to be a straight-chain or branched C₁₋₂₄alkoxy radical, that is to say O—C₁₋₂₄alkyl, preferably O—C₁₋₈alkyl, such as, for example, methoxy, ethoxy, n-propoxy, isopropoxy, n-butoxy, sec-butoxy, isobutoxy, tert-butoxy, n-pentyloxy, 2-pentyloxy, 3-pentyloxy, 2,2-dimethylpropoxy, n-hexyloxy, n-heptyloxy, n-otyloxy, 1,1,3,3-tetramethylbutoxy or 2-ethylhexyloxy.

In accordance with the invention, an aromatic carbocyclic ring or an aryl radical is understood to be a C₆₋₂₄aryl radical, preferably C₆₋₁₂aryl radical, which may be unsubstituted or substituted, such as, for example, phenyl, 4methylphenyl, 4methoxyphenyl, naphthyl, biphenylyl, 2-fluorenyl, phenanthryl, anthryl or terphenylyl.

In accordance with the invention, an aralkyl radical is understood to be a C₇₋₂₄aralkyl radical, preferably C₇₋₁₂aralkyl radical, which may be unsubstituted or substituted, such as, for example, benzyl, 2-benzyl-2-propyl, β-phenethyl, 9-fluorenyl, α,α-dimethylbenzyl, ω-phenyl-butyl, ω-phenyl-octyl, ω-phenyl-dodecyl or 3-methyl-5-(1′, 1′,3′,3′-tetramethyl-butyl)-benzyl.

As described above, the aforementioned radicals may be substituted by E and/or, if desired, interrupted by D. Interruptions are of course possible only in the case of radicals containing at least 2 carbon atoms connected to one another by single bonds; C₆-C₁₈aryl is not interrupted; interrupted arylalkyl or alkylaryl contains the unit D in the alkyl moiety. C₁-C₁₈alkyl substituted by one or more E and/or interrupted by one or more units D is, for example, (CH₂CH₂O)ₙ—R^{x}, where n is a number from the range 1-9 and R^{x} is H or C₁-C₁₀alkyl or C₂-C₁₀alkanoyl (e.g. CO—CH(C₂H₅)C₄H₉), CH₂—CH(OR^{y}′)—CH₂—O—R^{y}, where R^{y} is C₁-C₁₈alkyl, C₅-C₁₂cycloalkyl, phenyl, C₇-C₁₅phenylalkyl, and R^{y}′ embraces the same definitions as R^{y} or is H; C₁-C₈alkylene-COO—R^{z}, e.g. CH₂COOR^{z}. CH(CH₃)COOR^{z}, C(CH₃)₂COOR^{z}, where R^{z} is H, C₁-C₁₈alkyl, (CH₂CH₂O)₁₋₉—R^{x}, and R^{x} embraces the definitions indicated above; such as, for example, CH₂CH₂—O—CO—CH═CH₂⁻; CH₂CH(OH)CH₂—O—CO—C(CH₃)═CH₂.

—(CH₂)₂OCH₃, —(CH₂CH₂O)₂CH₂—CH₃, —CH₂—O—CH₃, —CH₂CH₂—O—CH₂CH₃, —CH₂CH₂CH₂—O—CH(CH₃)₂, —[CH₂CH₂O]_{Y1}—CH₃ wherein Y1=1-3, —CH₂CH(CH₃)—O—CH₂—CH₂CH₃ and —CH₂—CH(CH₃)—O—CH₂—CH₃.

In accordance with the present invention, the expression “a salt thereof” means the combination of an anion, such as —O⁻, —COO⁻ etc., and a metal cation, such as a sodium, potassium, lithium, calcium, a metal complex cation, or an ammonium cation.

In accordance with the present invention, the expression “ester group” encompasses carboxylic acid esters —C(O)OR¹⁰¹, phosphonic acid esters —P(O)OR¹⁰²OR¹⁰³ and phosphoric acid esters —OP(O)OR¹⁰²OR¹⁰³, wherein R¹⁰¹ is an unsubstituted or substituted alkyl, aryl or aralkyl radical or is an alkyl radical which is interrupted one or more times by —O— or by —S— and which is unsubstituted or substituted by a hydroxy group, R¹⁰² and R¹⁰³ are a hydrogen atom, an unsubstituted or substituted alkyl, aryl or aralkyl radical or are an alkyl radical which is interrupted one or more times by —O— or by —S— and which is unsubstituted or substituted by a hydroxy group, such as, for example, —C(O)OCH₂CH₂OCH₂CH₂OCH(CH₃)₂ and —C(O)OCH₂CH₂OCH₂CH₂OH.

The expression “sulfamide group” indicates a group —SO₂NR⁸R⁹ wherein R⁸ and R⁹ are as defined above.

Examples of an amino group —NR⁸R⁹ are amino, methylamino, ethylamino, dimethylamino, diethylamino, phenylamino, methoxycarbonylamino, acetylamino, ethylcarbonylamino, cyclohexylcarbonylamino, benzoylamino or chloroacetylamino, morpholino, piperidino or pyrrolidino.

A C₁₋₂₄alkoxycarbonyl radical is understood to be a straight-chain or branched.

C(O)O—C₁₋₂₄alkyl radical, preferably C(O)O—C₁₋₈alkyl radical, such as, for example, methoxy-, ethoxy-, n-propoxy-, isopropoxy-, n-butoxy-, sec-butoxy-, isobutoxy- or tertbutoxy-carbonyl.

Examples of a C₆₋₂₄aryl- or C₇₋₂₄aralkyl-carbonyl radical are a phenylcarbonyl group and a benzylcarbonyl group, respectively.

In accordance with the invention, an “ammonium group” is understood to be a group —NR¹⁰⁶R¹⁰⁷R¹⁰⁸ wherein R¹⁰⁶, R¹⁰⁷ and R¹⁰⁸ are a hydrogen atom or an unsubstituted or substituted alkyl, aryl or aralkyl radical.

Examples of an (aromatic) heterocylic ring (or ring system) are heterocycles having from 3 to 12 carbon atoms, for example 2-thienyl, 2-furyl, 1-pyrazolyl, 2-pyridyl, 2-thiazolyl, 2-oxazolyl, 2-imidazolyl, isothiazolyl, triazolyl or any other ring system consisting of thiophene, furan, pyrazole, thiazole, oxazole, imidazole, isothiazole, thiadiazole, triazole, pyridine or benzene rings unsubstituted or substituted by from 1 to 6 ethyl, methyl, ethylene and/or methylene substituents.

Examples of a saturated heterocylic ring are heterocycloalkanes having from 4 to 6 carbon atoms which have one or two hetero atom(s) selected from nitrogen, oxygen and sulfur, for example tetrahydrofuran, tetrahydropyran, 1,4-dioxane, thiolane, piperidine, γ-butyrolactone, 5-aminopentanoic acid lactam or pyrrolidine.

Examples of an aromatic carbocyclic ring or ring system are aromatic rings having from 6 to 24 carbon atoms, such as phenyl or naphthyl.

The definitions given hereinbefore for the radicals in formula (I) apply to the entire invention, unless otherwise specified.

If R² and R³ together form a five to seven membered heterocylic ring, metal complexes represented by formula 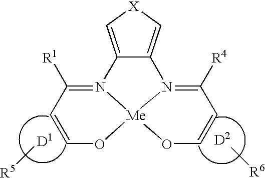
are preferred, wherein X is >O, >S, >S═O, or >S)₂, and R¹, R⁴, Me, D¹, D², R⁵ and R⁶ are defined as above.

In one aspect, the present invention relates to metal complexes of formula I, wherein at least one of the substituents R⁵ and at least one of the substituents R⁶ is an electron accepting group and R² and R³ together form an aromatic carbocyclic ring, which is substituted by at least one electron donating substituent. An example of such a compound is given below: 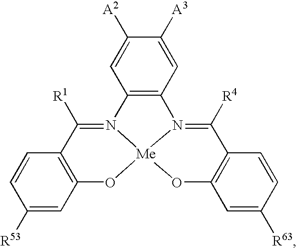
wherein

A² and A³ are an electron donating substituent, especially a hydroxy group, an C₁-C₁₈alkoxy group, an C₈-C₂₄aryloxy group, an C₇-C₂₄aralkyloxy group, or a group —NR⁸R⁹,

R⁵³ and R⁶³ are an electron accepting substituent, especially —NO₂, a halogen atom, especially a chlorine or a bromine atom, a group —SO₂—NR⁸R⁹, wherein R¹, R⁴, R⁸ and R⁹ are defined as above.

In a further more preferred aspect, the present invention relates to metal complexes of formula I, especially III, wherein at least one of the substituents R⁵ and at least one of the substituents R⁶ is an electron donating group and R² and R³ together form an aromatic carbocyclic ring, which is substituted by at least one electron accepting substituent.

Me is preferably a transition metal of Sub-Group 9, 10 or 11, especially Co³⁺, very especially Cu²⁺, Ni²⁺, Pd²⁺, Pt²⁺, Co²⁺, or Zn²⁺, R¹ and R⁴ preferably are a hydrogen atom, a C₁₋₄perfluoroalkyl radical, especially —CF₃ or —C₂F₅, or a C₁₋₄alkyl radical, especially a methyl or ethyl group.

R² and R³ are preferably a cyano group, or a group of formula 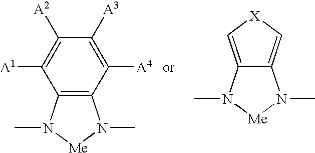
(N and Me are added for clarity reasons; the formed ring is highlighted in boldface), wherein X is >O, >S, >S═O, or >SO₂, A¹ and A⁴ are each independently of the other a hydrogen atom, an alkoxy radical, an alkyl radical, an alkyl radical which is interrupted one or more times by —O— or by —S—, at least one of A² and A³, preferably A² and A³, are an electron accepting substituent, especially —NO₂, a halogen atom, especially a chlorine or a bromine atom, a group —SO₂—NR⁸R⁹ and the other is a hydrogen atom.

Examples of groups D¹ and D² are: 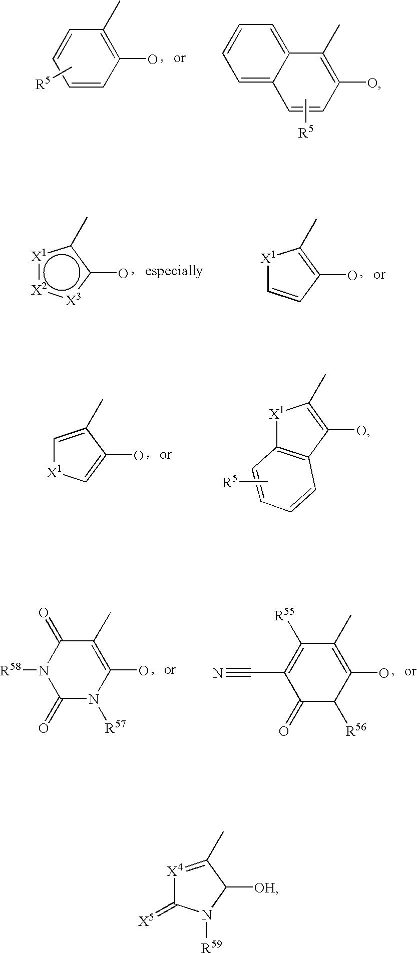
wherein X¹, X², X³ are a group ═CH—, —O—, —S—, or —NR²⁰⁰—, wherein R²⁰⁰ is a hydrogen atom, or an alkyl group. R⁵⁵ is a hydrogen atom, or a C₁-C₁₈alkyl group, R⁵⁶, R⁵⁷, R⁵⁸ and R⁵⁹ are each independently of the other a hydrogen atom, a C₁-C₁₈alkyl group, or a C₁-C₁₈alkyl group, which is interrupted by one or more oxygen atoms, X⁴ and X⁵ are each independently of the other a sulfur; or oxygen atom and R⁵ is as defined above.

Preferred groups D¹ and D² have the following structures: 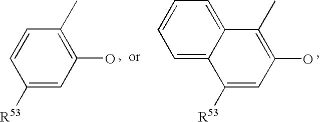
wherein

R⁵³ is OH, —OC₁-C₂₄alkyl, such as CH₃O—, C₂H₅O—, C₄H₉O—, C₈H₁₇O—, C₁₂H₂₅O—,3,5,5-trimethylhexyloxy-, or C₁₈H₃₇O—, R^{x}O—[CH₂CH₂—O—]ₓ wherein R^{x} is a methyl group and x is 1, or R^{x} is an ethyl group and x is 2, or R^{x} is a butyl group and x is 2, or R^{x} is a methyl group and x is 3, —NR⁸R⁹, wherein R⁸ and R⁹ are C₁-C₂₄alkyl, or (CH₂)_{y}—OH, wherein y is 1 to 24; or

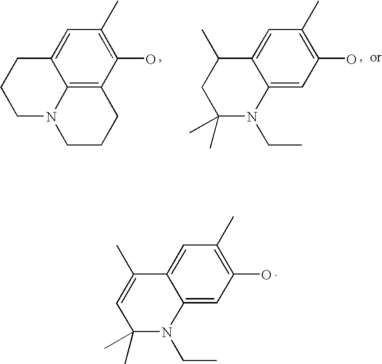

The metal complexes of formula (I) are coloured and make a contribution to the refractive index. The present invention accordingly relates also to the use, in the optical storage of information, of a metal complex of formula (I).

According to the present invention metal complexes having the following formula 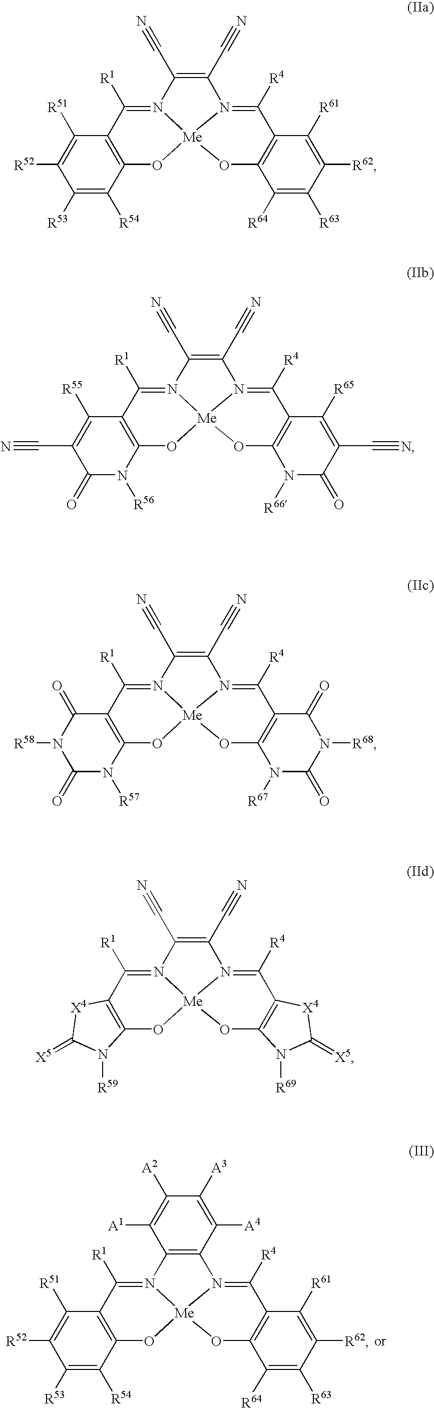 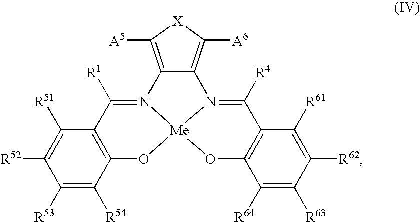
wherein

Me is Cu²⁺, Ni²⁺, Pd²⁺, Pt²⁺, Co²⁺, Co³⁺ or Zn²⁺,

X is >O, >S, >S═O, or >SO₂,

A¹, A⁴, A⁵ and A⁶ are each independently of the other a hydrogen atom, an alkoxy radical, an alkyl radical, an alkyl radical which is interrupted one or more times by —O— or by —S—,

at least one of A² and A³, preferably A² and A³, are an electron accepting substituent, especially —NO₂, a halogen atom, especially a chlorine or a bromine atom, a group —SO₂— NR⁸R⁹ and the other is a hydrogen atom,

R¹ and R⁴ are defined as in claim 1,

R⁵¹, R⁵², R⁵⁴, R⁶¹, R⁶² and R⁶⁴ are each independently of the other a hydrogen atom, or an C₁-C₁₈alkyl group,

R⁵³ and R⁶³ are each independently of the other a hydroxy group, an C₁-C₁₈alkoxy group, an C₈-C₂₄aryloxy group, an C₇-C₂₄aralkyloxy group, or a group —NR⁸R⁹, wherein R⁸ and R⁹ are each independently of the other a hydrogen atom, an C₁-C₁₈alkyl group, an C₁-C₁₈alkyl group which is substituted by E and/or interrupted by D, an C₆-C₂₄aryl group, an C₇-C₂₄aralkyl group, wherein D and E are as defined in claim 1, or a salt thereof, or

R⁵³ and R⁵², R⁵³ and R⁵⁴, R⁶³ and R⁶², and/or R⁶³ and R⁶⁴ are each independently of the other 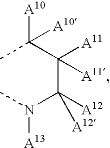
wherein A¹⁰, A^{10′}, A¹¹, A^{11′}, A¹² and A^{12′} are each independently of the other a hydrogen atom, or a C₁-C₆alkyl group, or

A^{10′} and A^{11′} together, form a double bond, and

A¹³ is a hydrogen atom or a C₁-C₈alkyl group, or

R⁵³ and R⁵² and R⁵⁴, and/or R⁶³ and R⁶² and R⁶⁴ are 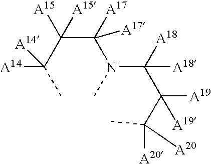
wherein A¹⁴, A^{14′}, A¹⁵, A^{15′}, A¹⁷, A^{17′}, A¹⁸, A^{18′}, A¹⁹, A^{19′}, A²⁰ and A^{20′} are each independently of the other a hydrogen atom, or a C₁-C₈alkyl group,

R⁵⁵ and R⁶⁵ are each independently of the other a hydrogen atom, or a C₁-C₁₈alkyl group,

R⁵⁸, R⁵⁷, R⁵⁸, R⁵⁹, R⁶⁶, R⁶⁷, R⁶⁸ and R⁶⁹ are each independently of the other a hydrogen atom, a C₁-C₁₈alkyl group, or a C₁-C₁₈alkyl group, which is interrupted by one or more oxygen atoms, and

X⁴ and X⁵ are each independently of the other a sulfur, or oxygen atom.

In formula II, III, or III the substituents have the following preferred meanings:

Me is Co³⁺, especially Cu²⁺, Ni²⁺, Pd²⁺, Pt²⁺, Co²⁺, or Zn²⁺,

X is >O, >S, >S═O, or >SO₂,

A¹, A⁴, A⁵ and A⁶ are a hydrogen atom,

A² and A³ are —NO₂,

R¹ and R⁴ are each independently of the other a hydrogen atom, a perfluoro C₁-C₈alkyl radical or a C₁-C₆alkyl radical,

R⁵¹, R⁵², R⁵⁴, R⁶¹, R⁶² and R⁶⁴ are a hydrogen atom, or

R⁵¹ and R⁵² together, and/or R⁶¹ and R⁶² together, form an unsubstituted or substituted phenyl ring,

R⁵³ and R⁶³ are each independently of the other a hydroxy group, an C₁-C₁₈alkoxy group, a group —NR⁸R⁹, wherein R⁸ and R⁹ are each independently of the other a hydrogen atom, an C₁-C₁₈alkyl group, a group —(CH₂)ₙ—OH, a group —(CH₂CH₂O)_{R}¹⁶, where n is a number from the range 1-9 and R¹⁶ is H or C₁-C₁₀alkyl, or a salt thereof, or

R⁵³ and R⁵², R⁵³ and R⁵⁴, R⁶³ and R⁶², and/or R63 and R64are each independently of the other 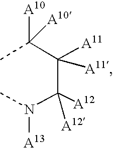
wherein A¹⁰, A^{10′}, A¹¹, A^{11′}, A¹² and A^{12′} are each independently of the other a hydrogen atom, or a C₁-C₈alkyl group, or

A^{10′} and A^{11′} together, form a double bond,

A¹³ is a hydrogen atom or a C₁-C₆alkyl group, or

R⁵³ and R⁵² and R⁵⁴, and/or R⁶³ and R⁶² and R⁶⁴ are 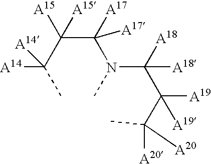
wherein A¹⁴, A^{14′}, A¹⁵, A^{15′}, A¹⁷, A^{17′}, A¹⁸, A^{18′}, A¹⁹, A^{19′}, A²⁰ and A^{20′} are each independently of the other a hydrogen atom, or a C₁-C₈alkyl group.

More preferred are metal complexes having the formula 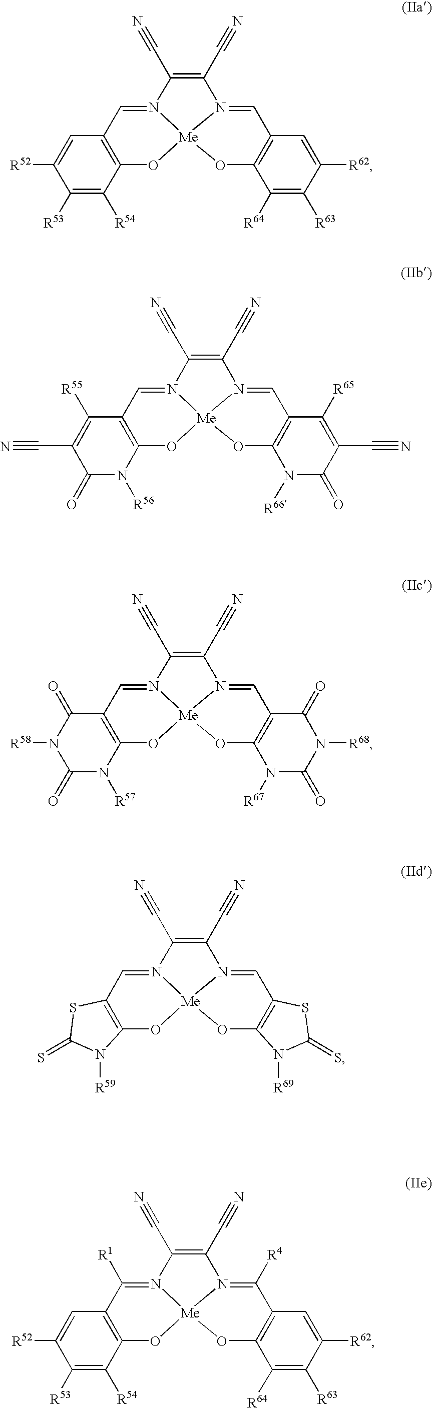 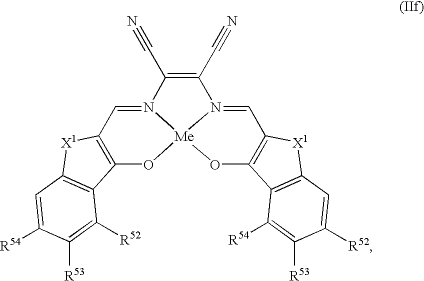
wherein X¹ is a group —O—, —S—, or —NR²⁰⁰—, wherein R²⁰⁰ is a hydrogen atom, or an alkyl group, R⁵⁵ and R⁶⁵ are each independently of the other a hydrogen atom, or a C₁-C₁₈alkyl group,

R⁵⁶, R⁵⁷, R⁵⁸, R⁵⁹, R⁶⁶, R⁶⁷, R⁶⁸ and R⁶⁹ are each independently of the other a hydrogen atom,

a C₁-C₁₈alkyl group, or a C₁-C₁₈alkyl group, which is interrupted by one or more oxygen atoms, 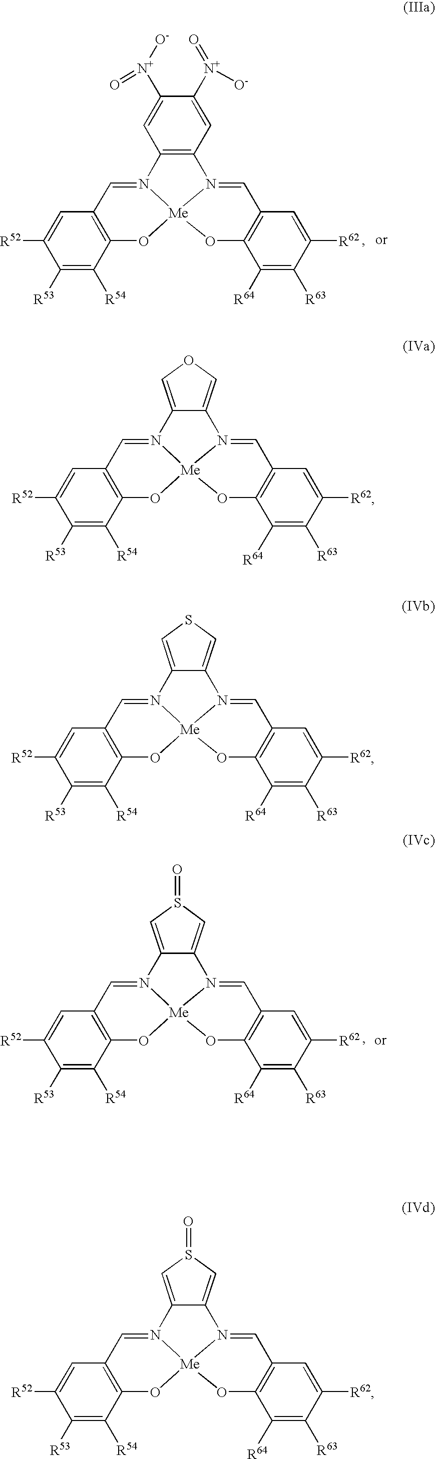
wherein

Me is Co³⁺, especially Cu²⁺, Ni²⁺, Pd²⁺, Pt²⁺, Co²⁺, or Zn²⁺,

R¹ is hydrogen and R⁴ is C₁-C₄perfluoroalkyl,

R⁵², R⁵⁴, R⁶² and R⁶⁴ are a hydrogen atom, or

R⁵³ and R⁶³ are each independently of the other a hydroxy group, an C₁-C₁₈alkoxy group, a group —NR⁸R⁹, wherein R⁸ and R⁹ are each independently of the other a hydrogen atom, an C₁-C₁₈alkyl group, a group —(CH₂)ₙ—OH, a group (CH₂CH₂O)ₙ—R¹⁶, where n is a number from the range 1-9 and R¹⁸ is H or C₁-C₁₀alkyl, or a salt thereof, or

R⁵³ and R⁵², R⁵³ and R⁵⁴, R⁶³ and R⁶², and/or R⁶³ and R⁶⁴ are each independently of the other a group of formula 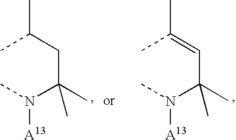
wherein

A¹³ a hydrogen atom or a C₁-C₈alkyl group, or

R⁵³ and R⁵² and R⁵⁴, and/or R⁶³ and R⁶² and R⁶⁴ are a group of formula

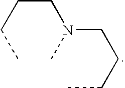

Most preferred are the metal complexes listed below:

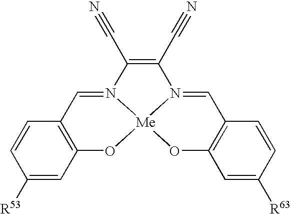

| Compound | R⁵³ = R⁶³ | Me |
|---|---|---|
| A-1 | —N(CH₂)₂OH | Ni²⁺ |
| A-2 | —N(CH₂)₂OH | Cu²⁺ |
| A-3 | —N(CH₂)₂OH | Co²⁺ |
| A-4 | —OH | Ni²⁺ |
| A-5 | —OH | Cu²⁺ |
| A-6 | —OH | Co²⁺ |
| A-7 | —ONa | Ni²⁺ |
| A-8 | —ONa | Cu²⁺ |
| A-9 | —ONa | Co²⁺ |

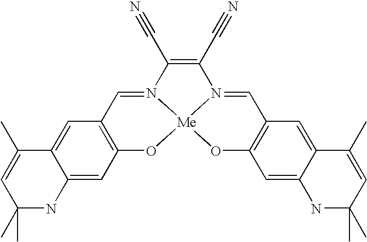

A-10 (Me = Ni²⁺)
A-11 (Me = Cu²⁺)
A-12 (Me = Co²⁺)

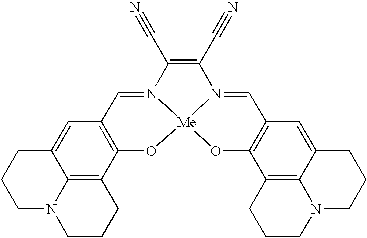

A-13 (Me = Ni²⁺)
A-14 (Me = Cu²⁺)
A-15 (me = Co²⁺)

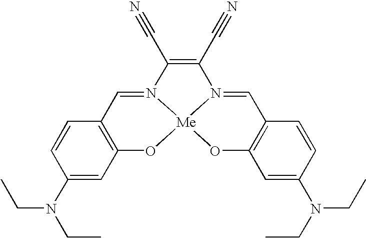

A-16 (Me = Ni²⁺)
[582 nm (ε = 82000;
n = 2.08; k = 0.064]
A-17 (Me = Cu²⁺)
A-18 (Me = Co²⁺)

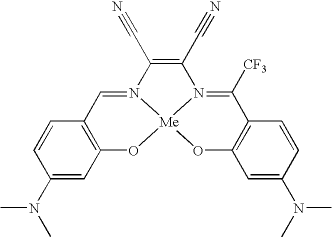

A-19 (Me = Ni²⁺)
A-20 (Me = Cu²⁺)
A-21 (Me = Co²⁺)

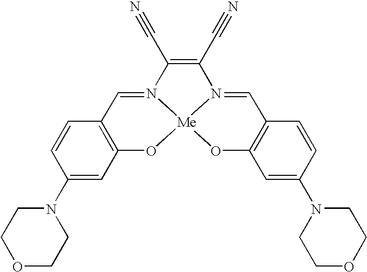

A-22 (Me = Ni²⁺)
A-23 (Me = Cu²⁺)
A-24 (Me = Co²⁺)

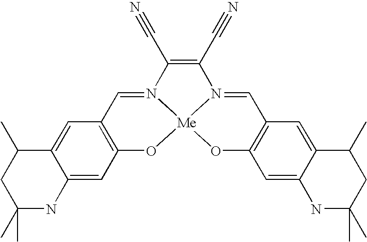

A-25 (Me = Ni²⁺)
A-26 (Me = Cu²⁺)
A-27 (Me = Co²⁺)

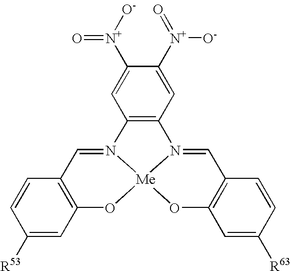

| Compound | R⁵³ = R⁶³ | Me |
|---|---|---|
| B-1 | —N(CH₂)₂OH | Ni²⁺ |
| B-2 | —N(CH₂)₂OH | Cu²⁺ |
| B-3 | —N(CH₂)₂OH | Co²⁺ |
| B-4 | —OH | Ni²⁺ |
| B-5 | —OH | Cu²⁺ |
| B-6 | —OH | Co²⁺ |
| B-7 | —ONa | Ni²⁺ |
| B-8 | —ONa | Cu²⁺ |
| B-9 | —ONa | Co²⁺ |
| B-10 | —ONH₄ | Ni²⁺ |
| B-11 | —ONH₄ | Cu²⁺ |
| B-12 | —ONH₄ | Cu²⁺ |

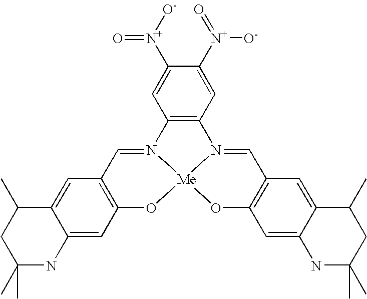

B-13 (Me = Ni²⁺)
B-14 (Me = Cu²⁺)
B-15 (Me = Co²⁺)

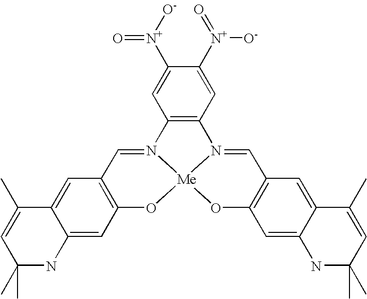

B-16 (Me = Ni²⁺)
B-17 (Me = Cu²⁺)
B-18 (Me = Co²⁺)

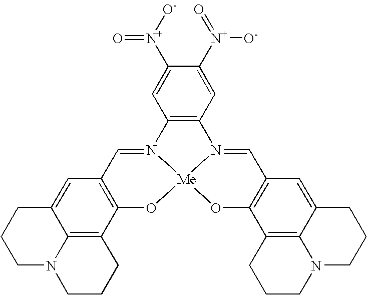

B-19 (Me = Ni²⁺)
B-20 (Me = Cu²⁺)
B-21 (Me = Co²⁺)

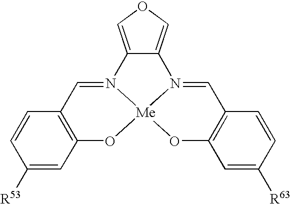

| Compound | R⁵³ = R⁶³ | Me |
|---|---|---|
| C-1 | —N(CH₂)₂OH | Ni²⁺ |
| C-2 | —N(CH₂)₂OH | Cu²⁺ |
| C-3 | —N(CH₂)₂OH | Co²⁺ |
| C-4 | —OH | Ni²⁺ |
| C-5 | —OH | Cu²⁺ |
| C-6 | —OH | Co²⁺ |

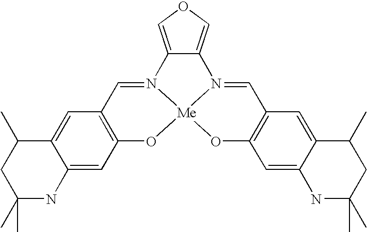

C-7 (Me = Ni²⁺)
C-8 (Me = Cu²⁺)
C-9 (Me = Co²⁺)

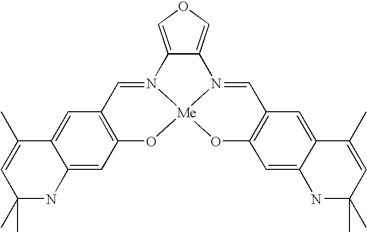

C-10 (Me = Ni²⁺)
C-11 (Me = Cu²⁺)
C-12 (Me = Co²⁺)

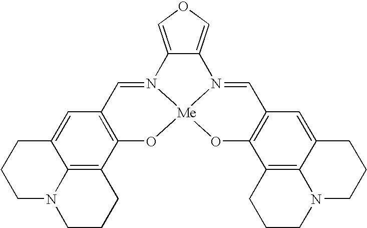

C-13 (Me = Ni²⁺)
C-14 (Me = Cu²⁺)
C-15 (Me = Co²⁺)

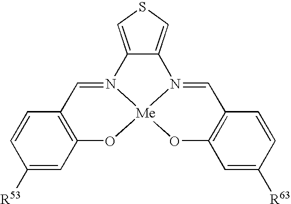

| Compound | R⁵³ = R⁶³ | Me |
|---|---|---|
| D-1 | —N(CH₂)₂OH | Ni²⁺ |
| D-2 | —N(CH₂)₂OH | Cu²⁺ |
| D-3 | —N(CH₂)₂OH | Co²⁺ |
| D-4 | —OH | Ni²⁺ |
| D-5 | —OH | Cu²⁺ |
| D-6 | —OH | Co²⁺ |

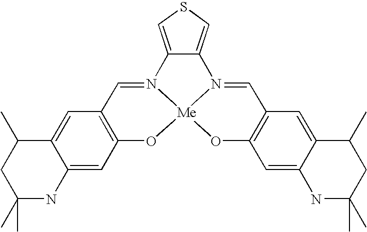

D-7 (Me = Ni²⁺)
D-8 (Me = Cu²⁺)
D-9 (Me = Co²⁺)

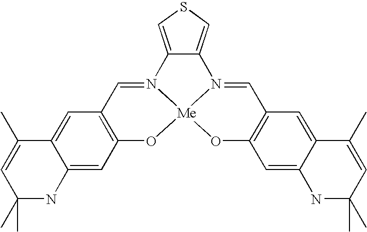

D-10 (Me = Ni²⁺)
D-11 (Me = Cu²⁺)
D-12 (Me = Co²⁺)

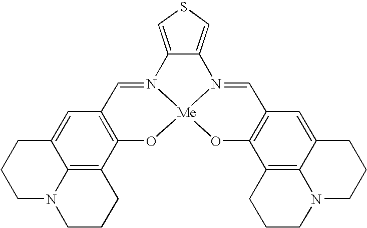

D-13 (Me = Ni²⁺)
D-14 (Me = Cu²⁺)
D-15 (Me = Co²⁺)

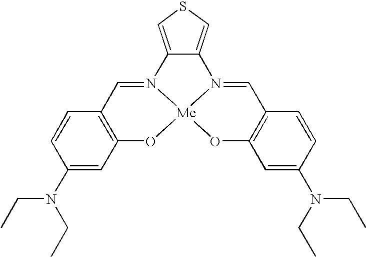

D-16 (Me = Ni²⁺)
D-17 (Me = Cu²⁺)
D-18 (Me = Co²⁺)

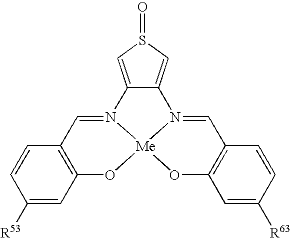

| Compound | R⁵³ = R⁶³ | Me |
|---|---|---|
| E-1 | —N(CH₂)₂OH | Ni²⁺ |
| E-2 | —N(CH₂)₂OH | Cu²⁺ |
| E-3 | —N(CH₂)₂OH | Co²⁺ |
| E-4 | —OH | Ni²⁺ |
| E-5 | —OH | Cu²⁺ |
| E-6 | —OH | Co²⁺ |

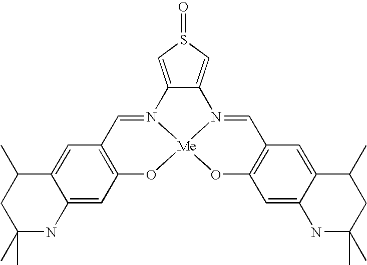

E-7 (Me = Ni²⁺)
E-8 (Me = Cu²⁺)
E-9 (Me = Co²⁺)

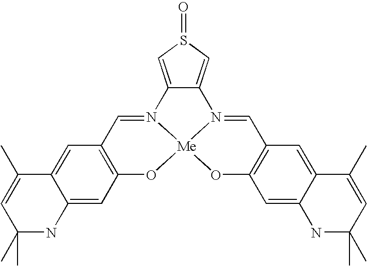

E-10 (Me = Ni²⁺)
E-11 (Me = Cu²⁺)
E-12 (Me = Co²⁺)

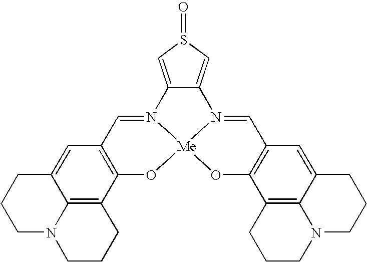

E-13 (Me = Ni²⁺)
E-14 (Me = Cu²⁺)
E-15 (Me = Co²⁺)

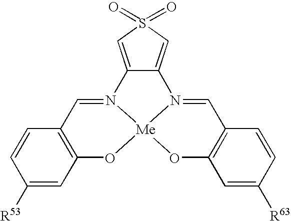

| Compound | R⁵³ = R⁶³ | Me |
|---|---|---|
| F-1 | —N(CH₂)₂OH | Ni²⁺ |
| F-2 | —N(CH₂)₂OH | Cu²⁺ |
| F-3 | —N(CH₂)₂OH | Co²⁺ |
| F-4 | —OH | Ni²⁺ |
| F-5 | —OH | Cu²⁺ |
| F-6 | —OH | Co²⁺ |

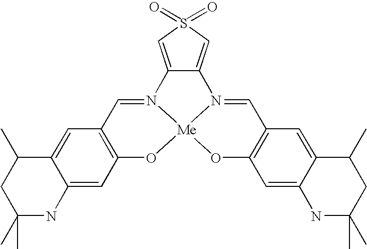

F-7 (Me = Ni²⁺)
F-8 (Me = Cu²⁺)
F-9 (Me = Co²⁺)

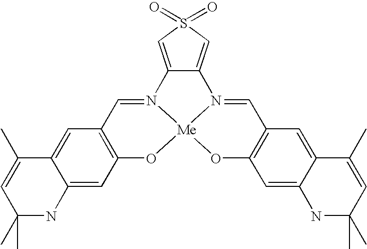

F-10 (Me = Ni²⁺)
F-11 (Me = Cu²⁺)
F-12 (Me = Co²⁺)

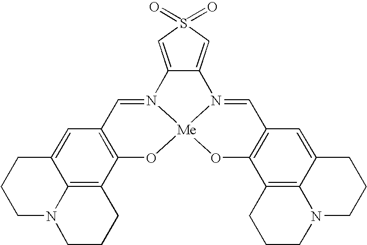

F-13 (Me = Ni²⁺)
F-14 (Me = Cu²⁺)
F-15 (Me = Co²⁺)

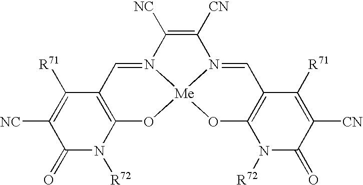

| Compound | R⁷¹ | R⁷² | Me |
|---|---|---|---|
| G-1 | —CH₃ | —CH₃ | Ni²⁺ |
| G-2 | —CH₃ | —CH₃ | Cu²⁺ |
| G-3 | —CH₃ | —CH₃ | Co²⁺ |
| G-4 | —CH₃ | —(CH₂)₃OCH(CH₃)₂ | Ni²⁺ |
| G-5 | —CH₃ | —(CH₂)₃OCH(CH₃)₂ | Cu²⁺ |
| G-6 | —CH₃ | —(CH₂)₃OCH(CH₃)₂ | Co²⁺ |
| G-7 | —CH₃ | H | Ni²⁺ |
| G-8 | —CH₃ | H | Cu²⁺ |
| G-9 | —CH₃ | H | Co²⁺ |

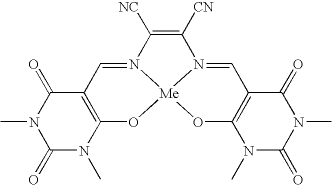

H-1 (Me = Ni²⁺)
H-2 (Me = Cu²⁺)
H-3 (Me = Co²⁺)

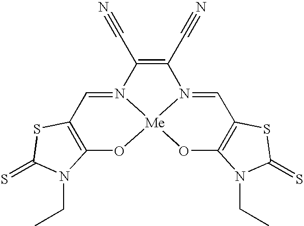

I-1 (Me = Ni²⁺)
I-2 (Me = Cu²⁺)
I-3 (Me = Co²⁺)

The metal complexes described hereinbefore can be prepared in accordance with, or in analogy to, methods described in WO03/042989, EP-A-200 843, EP-A-162 811, EP-A-362 139 and EP-A-436 470.

In a further aspect, the present invention relates to compositions, comprising

(a) a metal complex according to the present invention, including

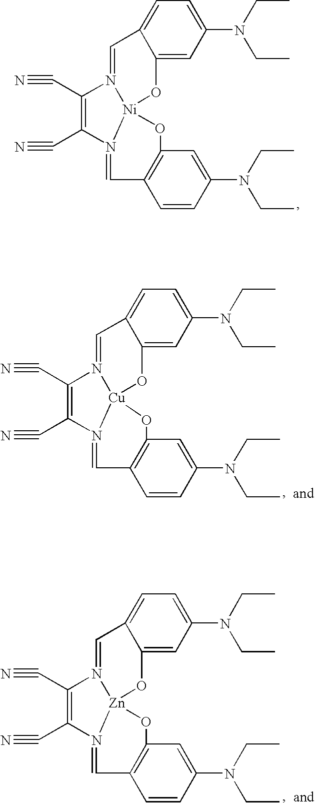

(b) a dye.

Further chromophores (dyes) that can be used in the recording layer in addition to the compounds of formula I, II, III or IV are, for example, cyanines and cyanine metal complexes (U.S. Pat. No. 5,958,650), styryl compounds (U.S. Pat. No. 6,103,331), oxonol dyes (EP-A-833 314, U.S. Pat. No. 6,225,024), azo dyes and azo metal complexes (JP-A-11/028865), phthalocyanines (EP-A-232 427, EP-A-337 209, EP-A-373 643, EP-A-463 550, EP-A-492 508, EP-A-509 423, EP-A-511 590, EP-A-513 370, EP-A-514 799, EP-A-518 213, EP-A-519 419, EP-A-519 423, EP-A-575 816, EP-A-600 427, EP-A-676 751, EP-A-712 904, WO-98/14520, WO-00/09522, CH-693/01), porphyrins and azaporphyrins (EP-A-822 546, U.S. Pat. No. 5,998,093), dipyrromethene dyes and metal chelate compounds thereof (EP-A-822 544, EP-A-903 733), xanthene dyes and metal complex salts thereof (U.S. Pat. No. 5,851,621) or quadratic acid compounds (EP-A-568 877 ), or oxazines, dioxazines, diazastyryls, formmazans, anthraquinones or phenothiazines; as well as the rhodamines and rhodamine/quencher mixtures described in WO03/098617, especially examples 1 to 75 of WO03/098617, and WO03/098618, especially examples 1 to 48 of WO03/098618.

Examples of suitable dyes are non-charged diaza-styrylium chromophores, where quaternization is achieved by complexation of the heterocyclic nitrogen by a heavy metal cation instead of an alkyl group, especially 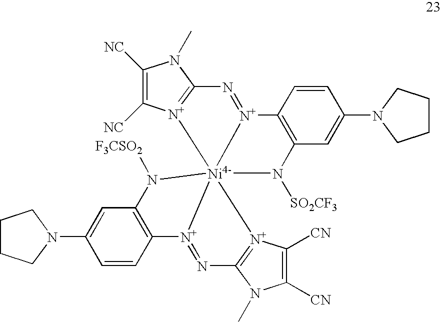
or a mixture of the above chromophore with the below quenchers or a mixture of the below quenchers, 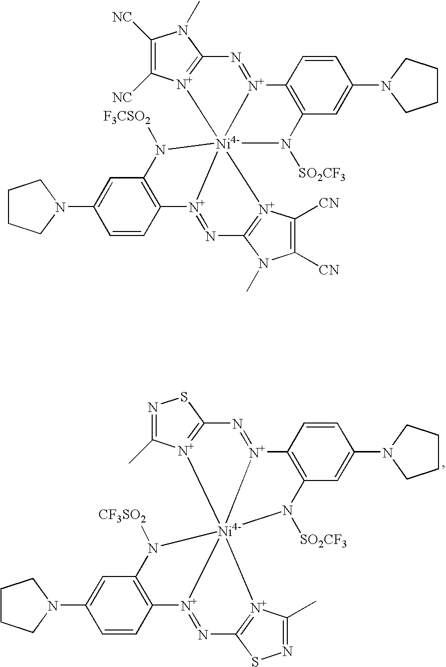
squarylium dyes and optionally a 1:2 nickel formazane dye as a quencher, especially

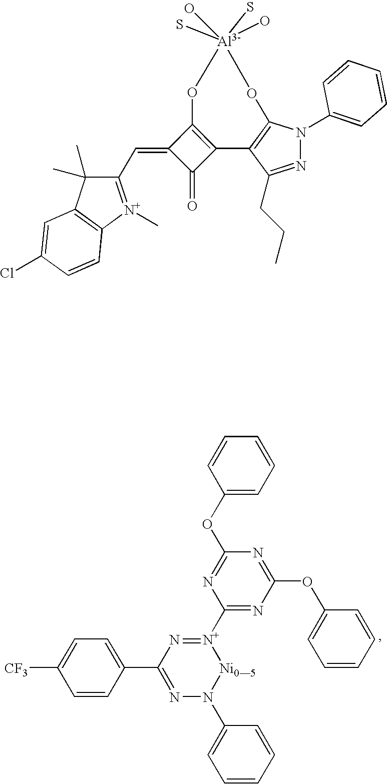

SQ=SQUARYLIUM CHROMOPHORE
an anionic oxonol dye (or mixture of oxonol dyes) is combined with a cationic quencher (paraquat type), especially 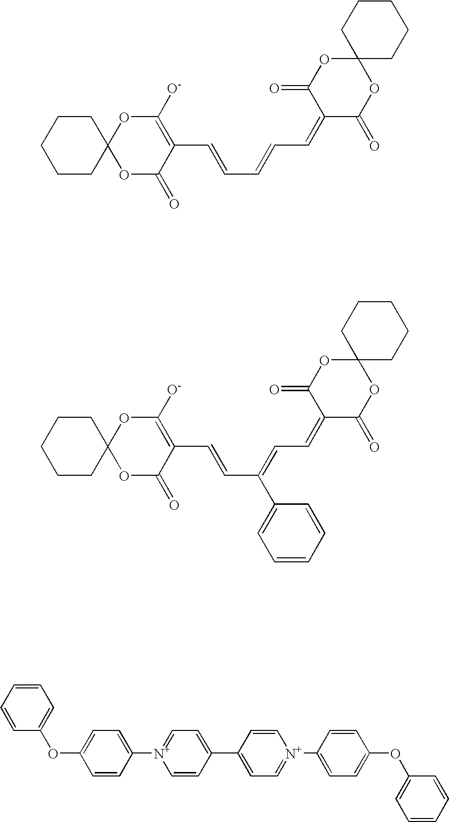
dipyrromethene chromophores, especially 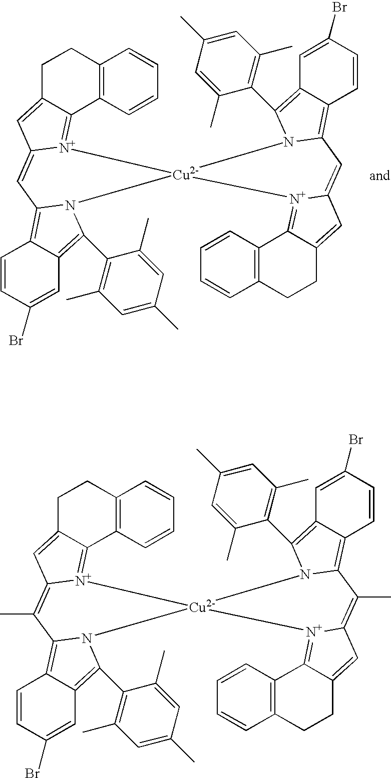
cyanine dyes, especially 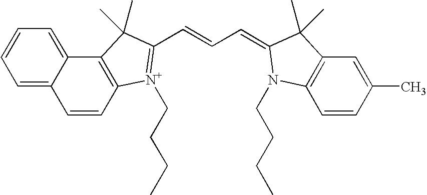
or cyanine dyes in combination with quenchers of the quinone-diammonium (Kayasorb) type or metal azo complexes, especially 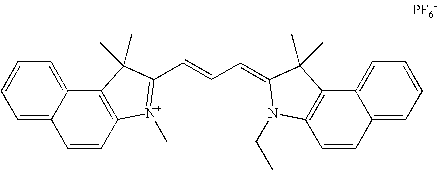
or cyanine dyes combined with an azo cobalt complex (in part as ion-pair), especially 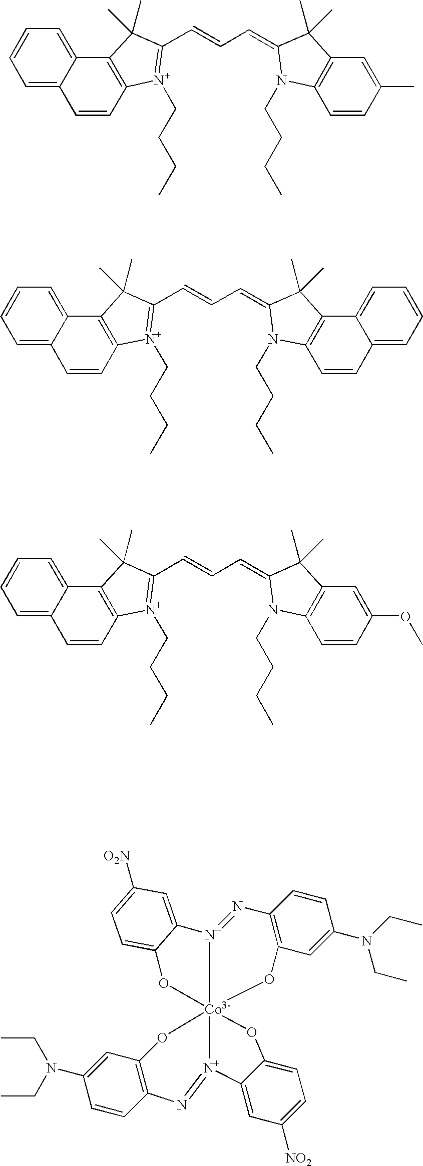
or mixtures of cyanine dyes, especially

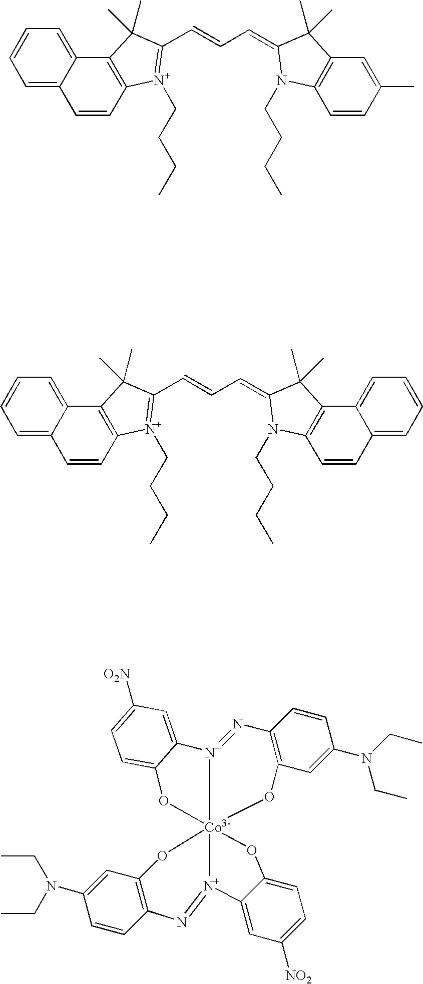

Preferably, the compositions comprise a metal complex of formula I, II, III or IV, wherein Me is Ni²⁺, Cu²⁺, or Co²⁺, and an oxonol dye of formula 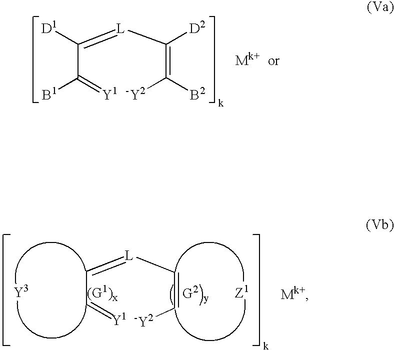
described in WO03/042989,
wherein D¹, D², B¹ and B² are in each case a substituent; Y³ and Z¹ are in each case a group of atoms necessary for the formation of a carbocyclic or heterocylic ring; G¹ and G² are in each case a group of atoms necessary for the formation of a chain having conjugated double bonds; Y¹ is ═O, ═NR¹⁰⁹ or ═C(CN)₂, R¹⁰⁹ being a substituent; Y² is —O, —NR¹⁰⁹ or —C(CN)₂, R¹⁰⁹ being a substituent; L is a methine group, which may be substituted, or a group by means of which a polymethine group is completed, it being possible for 3, 5 or 7 methine groups to be connected in order to form a chain having conjugated double bonds, which chain may be substituted, x and y are 0 or 1, M^{k+} is an organic or inorganic cation, and k is an integer from 1 to 10.

Oxonois having formula 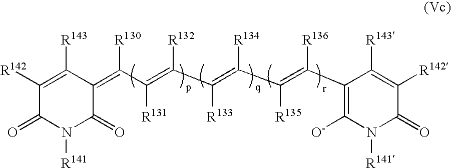
wherein R¹³⁰, R¹³¹, R¹³², R¹³³, R¹³⁴, R¹³⁵ and R¹³⁶, p, q and r are as defined below and R¹⁴¹ and R^{141′} are each independently of the other a hydrogen atom, an unsubstituted or substituted C₁₋₁₂alkyl radical, C₅₋₇cycloalkyl, C₆₋₁₂aryl, C₇₋₁₂aralkyl radical or heterocylic radical,

R¹⁴² and R^{142′} are each independently of the other a hydrogen atom, a cyano group, a group C(O)OR¹⁴⁶, C(O)NR¹⁴⁶R¹⁴⁷ or C(O)R¹⁴⁷, an unsubstituted or substituted C₁₋₁₂alkyl radical, C₅₋₇Cycloalkyl, C₆₋₁₂aryl, C₇₋₁₂aralkyl radical or heterocylic radical, R¹⁴⁸ and R¹⁴⁷ being an unsubstituted or substituted C₁₋₁₂alkyl radical, C₅₋₇cycloalkyl, C₆₋₁₂aryl, C₇₋₁₂aralkyl radical or heterocyclic radical, or R¹⁴⁶ and R¹⁴⁷, together with the nitrogen atom to which they are bonded, forming a five- or six-membered ring, and

R¹⁴³ and R^{143′} are each independently of the other a hydrogen atom, a carboxylic acid group or an alkyl radical; especially oxonol dyes of the following general formula 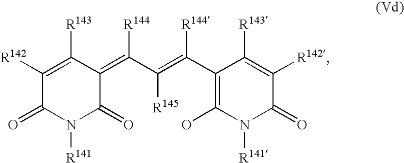
wherein

R¹⁴¹ and R^{141′} are each independently of the other a hydrogen atom, a C₁₋₄alkyl radical, such as methyl or ethyl, or a perfluoro-C₁₋₄alkyl radical, such as trifluoromethyl, a hydroxy-C₁₋₄alkyl radical, or a C₁₋₈alkyl radical interrupted one or more times by —O—, such as CH₂CH₂CH₂—O—CH(CH₃)₂, a C₆₋₁₀aryl radical, such as phenyl, or a C₇₋₁₂aralkyl radical such as benzyl,

R¹⁴² and R^{142′} are each independently of the other a hydrogen atom, a cyano or carboxamide group.

R¹⁴³ and R^{143′} are each independently of the other a hydrogen atom, a carboxylic acid group or a salt thereof or a C₁₋₄alkyl radical,

R¹⁴⁴ and R^{144′} are each independently of the other a hydrogen atom, a C₁₋₄alkyl radical, a C₆₋₁₂aryl or C₇₋₁₂aralkyl radical, or

R¹⁴⁴ and R^{144′} together form a five-membered or six-membered ring, such as a cyclohexenyl or cyclopentenyl ring, and

R¹⁴⁵ is a hydrogen atom, a halogen atom, especially a chlorine atom, an unsubstituted or C₁₋₄alkyl- or C₁₋₄alkoxy-substituted C₆₋₁₂aryl radical, such as phenyl or p-methylphenyl, or C₇₋₁₂aralkyl radical, such as benzyl, or

oxonol dyes of the following general formula 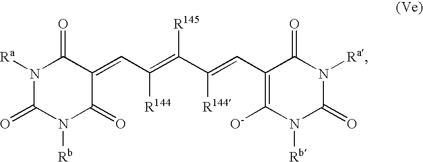
wherein R^{a}, R^{b}, R^{a′} and R^{b′} are each independently of the other a hydrogen atom, a C₁₋₈alkyl radical, in particular a C₁₋₄alkyl radical, a hydroxy-C₁₋₈alkyl radical, a C₁₋₈alkenyl radical, such as —CH₂—CH═CH₂, an unsubstituted or C₁₋₄alkyl- or C₁₋₄alkoxy-substituted C₆₋₁₂aryl, such as phenyl, or C₇₋₁₂aralkyl radical, such as benzyl,

R¹⁴⁴ and R^{144′} are each independently of the other a hydrogen atom, a C₁₋₄alkyl radical, a C₆₋₁₂aryl or C₇₋₁₂aralkyl radical, or

R¹⁴⁴ and R^{144′} together form a five-membered or six-membered ring, such as a cyclohexenyl or cyclopentenyl ring, and

R¹⁴⁵ is a hydrogen atom, a halogen atom, especially a chlorine atom, an unsubstituted or C₁₋₄alkyl- or C₁₋₄alkoxy-substituted C₆₋₁₂aryl radical, such as phenyl or p-methylphenyl, or C₇₋₁₂aralkyl radical, such as benzyl.

Special preference is given to ion pairs of a metal complex of formula I, II, III or IV, wherein Me is Co²⁺, Ni²⁺ or Cu²⁺ and an oxonol dye of formula 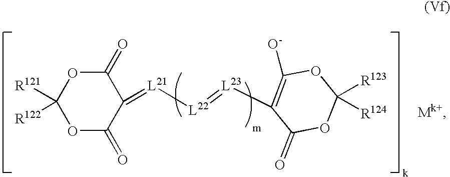
described in

U.S. Pat. No 6,225,024, wherein R¹²¹, R¹²², R¹²³ and R¹²⁴ are each independently of the others a hydrogen atom, a substituted or unsubstituted alkyl radical, a substituted or unsubstituted aryl radical, a substituted or unsubstituted aralkyl radical or a substituted or unsubstituted heterocylic radical, L²¹, L²² and L²³ are each independently of the others a methine group which may have a substituent, m is an integer 0, 1, 2 or 3, provided that when m is 2 or 3 the groups L²² and L²³ may be the same or different, k and M^{k+} are as defined above.

Special preference is given to oxonol compounds of formula 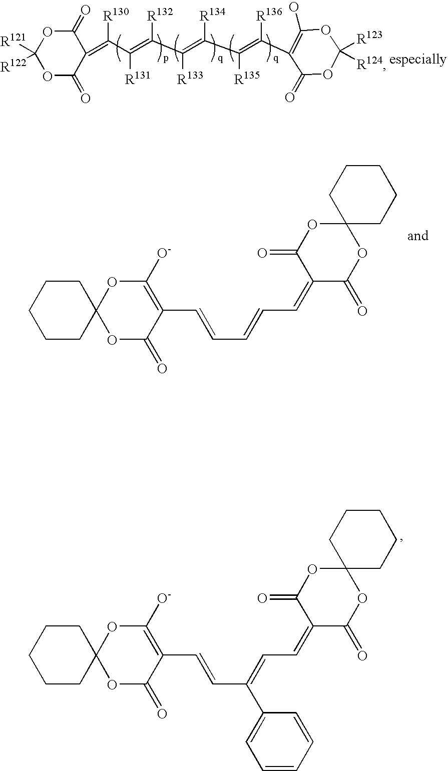
wherein R¹²¹, R¹²², R¹²³ and R¹²⁴ are each independently of the others a hydrogen atom, a C₁₋₈alkyl radical, a C₁₋₈perfluoroalkyl radical, such as trifluoromethyl, a C₁₋₈alkenyl radical, a C₁₋₄alkoxy-C₁₋₄alkyl radical, a hydroxy-C₁₋₄alkyl radical, a R⁸R⁹N—C₁₋₄alkyl radical, R⁸ and R⁹ being as defined hereinbefore, a C₆₋₁₀aryl radical, such as phenyl, a C₇₋₁₀aralkyl radical, such as benzyl, or a heterocyclic ring having from 2 to 10 carbon atoms, or

R¹²¹and R¹²² together, and/or R¹²³ and R¹²⁴ together, form an unsubstituted or substituted carbocyclic ring, preferably having from 3 to 10 carbon atoms, such as cyclopropyl, cyclobutyl, cyclopentyl, cyclohexyl, 2-methylcyclohexyl, cycloheptyl or cyclooctyl, or an unsubstituted or substituted heterocylic ring, preferably having from 2 to 10 carbon atoms, such as piperidyl, chromanyl or morpholyl, which rings may be unsubstituted or substituted by one or more C₁₋₄alkyl and/or C₁₋₄alkoxy radicals,

R¹³⁰, R¹³¹, R¹³², R¹³³, R¹³⁴, R¹³⁵ and R¹³⁶ are each independently of the others a hydrogen atom, a halogen atom, such as chlorine or bromine, a C₁₋₈-alkyl radical, a C₁₋₈perfluoroalkyl radical, such as trifluoromethyl, a C₆₋₁₀aryl radical, such as phenyl, a C₇₋₁₀aralkyl radical, such as benzyl, or a heterocylic ring having from 2 to 10 carbon atoms, or

two substituents R¹³⁰, R¹³¹, R¹³², R¹³³, R¹³⁴, R¹³⁵ and R¹³⁶, which are located in 1,3-positions relative to one another, together form an unsubstituted or substituted carbocyclic ring having 5 or 6 carbon atoms, such as cyclohexenyl or cyclopentenyl, which may be unsubstituted or substituted by one or more C₁₋₄alkyl and/or C₁₋₄alkoxy radicals, and p, q and r are 0 or 1.

If Me is Cu²⁺, Ni²⁺, Pd²⁺, Pt²⁺, Co²⁺, or Zn²⁺, i.e. the metal complex is neutral, the oxonols of formula V are used in combination with an organic or inorganic cation. Examples of cations are hydrogen cations, metal cations, such as a sodium, potassium, lithium, calcium, iron and copper ion, a metal complex cation, an ammonium cation, including cationic dyes and a pyridinium cation, an oxonium, sulfonium, phosphonium, selenium and iodonium ion. In accordance with the invention, the cation is generally selected from ammonium cations, and cationic dyes as described in WO03/042989.

A further aspect of the present invention is directed to an optical recording medium comprising a substrate and at least one recording layer, wherein the recording layer comprises a metal complex according to the present invention, including 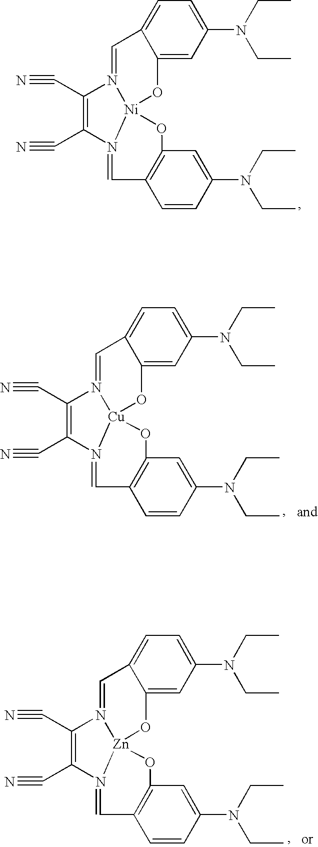
a composition according to the present invention.

Accordingly, the present invention also relates to the use of a metal complex according to the present invention or a composition according to the present invention in the production of optical recording media.

The recording layer may also comprise, instead of a single oxonol dye, a mixture of such compounds with, for example, 2, 3, 4 or 5 oxonol dyes. The use of mixtures, for example mixtures of isomers or homologues but also mixtures of differing structures, can often result in an increase in solubility and/or a reduction in the tendency to aggregate. Where appropriate, mixtures of ion-pair compounds may have differing anions, differing cations or both differing anions and differing cations.

The oxonol dyes used in accordance with the invention have, in combination with the metal complexes of formula (I), a narrow absorption band whose maximum is located at from 540 to 640 nm or in the range lower than 450 nm. The use of metal complexes of formula (I) results, surprisingly, in a comparatively weak tendency of the oxonol dyes to aggregate in the solid state so that the absorption curve remains advantageously narrow even in the solid state.

The metal complexes or compositions used in accordance with the invention, in the form of a solid film, as used in optical storage media, have, on the longer-wavelength flank of the absorption band, a high refractive index which reaches a peak value of from 2.0 to 3.0 in the range from 600 to 700 nm and more than 1.9 in the range from 390 to 430 nm, so that a medium having high reflectivity as well as high sensitivity and good playback characteristics in the desired spectral range can be achieved.

The substrate, which functions as support for the layers applied thereto, is advantageously semi-transparent (T≧10%) or, preferably, transparent (T≧90%). The support generally has a thickness of from 0.01 to 10 mm, preferably from 0.1 to 5 mm.

The recording layer Is located preferably between the transparent substrate and the reflecting layer. The thickness of the recording layer is from 10 to 1000 nm, preferably from 30 to 300 nm, especially from 60 to 120 nm. The absorption of the recording layer is generally from 0.1 to 1.0 at the absorption maximum. The layer thickness is very especially so selected in dependence upon the respective refractive indices in the non-written state and in the written state at the reading wavelength that, in the non-written state, constructive interference is obtained but, in the written state, destructive interference is obtained, or vice versa.

The reflecting layer, the thickness of which can be from 10 to 150 nm, preferably has high reflectivity (R≧45%, especially R≧60%), coupled with low transparency (T≦10%). In further embodiments, for example in media having a plurality of recording layers, the reflector layer may likewise be semi-transparent, that is to say may have comparatively high transparency (for example T≧50%) and low reflectivity (for example R≦45%).

The uppermost layer, for example the reflective layer or the recording layer, depending upon the layer structure, is advantageously additionally provided with a protective layer having a thickness of generally from 0.1 to 1000 μm, preferably from 0.1 to 50 μm and especially from 0.5 to 15 μm. Such a protective layer can, if desired, serve also as adhesion promoter for a second substrate layer applied thereto, which is preferably from 0.1 to 5 mm thick and consists of the same material as the support substrate.

The reflectivity of the entire recording medium is preferably at least 15%, especially at least 40% (for example 45% for DVD-R).

The main features of the recording layer according to the invention are the very high initial reflectivity in the said wavelength range of the laser diodes, which reflectivity can be modified with especially high sensitivity: the high refractive index; the narrow absorption band in the solid state; the good uniformity of the script width at different pulse durations; the good light-stability; and the good solubility In non-halogenated solvents, especially alcohols.

The use of the metal complexes or compositions according to the Invention results in advantageously homogeneous, amorphous and low-scatter recording layers having a high refractive index, and the absorption edge is surprisingly especially steep even in the solid phase. Further advantages are high light-stability in daylight and under laser radiation of low power density with, at the same time, high sensitivity under laser radiation of high power density, uniform script width, high contrast, and also good thermal stability and storage stability.

At a relatively high recording speed, the results obtained are surprisingly better than with previously known recording media. The marks are more precisely defined relative to the surrounding medium and thermally induced deformations do not occur. The error rate (BLER or Pi Sim 8) and the statistical variations in mark length (jitter) are also low both at normal and at relatively high recording speed, so that error-free recording and playback can be achieved over a large speed range. The advantages are obtained in the entire range from 600 to 700 nm (preferably from 630 to 690 nm), but are especially pronounced at 640-680 nm, more especially at from 650 to 670 nm, very especially at 658±5 nm.

Suitable substrates are, for example, glass, minerals, ceramics and thermosetting or thermoplastic plastics. Preferred supports are glass and homo- or co-polymeric plastics. Suitable plastics are, for example, thermoplastic polycarbonates, polyamides, polyesters, polyacrylates and polymethacrylates, polyurethanes, polyolefins, polyvinyl chloride, polyvinylidene fluoride, polyimides, thermosetting polyesters and epoxy resins. The substrate can be in pure form or may also comprise customary additives, for example UV absorbers or dyes, as proposed, for example, in JP 04/167239 as light-stabilisers for the recording layer. In the latter case it may be advantageous for the dye added to the support substrate to have an absorption maximum hypsochromically shifted relative to the dye of the recording layer by at least 10 nm, preferably by at least 20 nm.

The substrate is advantageously transparent over at least a portion of the range from 600 to 700 nm so that it is permeable to at least 90% of the incident light of the writing or readout wavelength. The substrate has preferably on the coating side a spiral guide groove having a groove depth of from 50 to 500 nm, a groove width of from 0.2 to 0.8 μm and a track spacing between two turns of from 0.4 to 1.6 μm, especially having a groove depth of from 100 to 200 nm, a groove width of 0.3 μm and a spacing between two turns of from 0.6 to 0.8 μm. The compositions according to the invention are therefore suitable especially advantageously for use in DVD media having the currently customary pit width of 0.4 μm and track spacing of 0.74 μm.

For a further increase in stability it is also possible, if desired, to add known stabilisers in customary amounts, such as, for example, a nickel dithiolate described in JP 04/025 493 as light-stabiliser.

If an oxonol dye Is used in combination with a metal complex of formula I, the recording layer comprises an oxonol dye or a mixture of such compounds advantageously in an amount sufficient to have a substantial influence on the refractive index. Such an amount is generally at least 30% by weight, preferably at least 60% by weight, especially at least 80% by weight.

Suitable concentrations of metal complex oompound(s) of formula (I) are generally from 1 to 1000% by weight, preferably from 30 to 60% by weight, based on the oxonol compound(s). The recording media may comprise customary additives, for example film-formers, further customary constituents, such as, for example, other chromophores (for example those having an absorption maximum at from 300 to 1000 nm), UV absorbers and/or other stabilisers, quenchers, such as, for example, fluorescence quenchers, melting-point depressants and decomposition accelerators.

Besides the metal complexes of formula I, further stabilisers or fluorescence quenchers may be used, for example metal complexes of nitrogen- or sulfur-containing enolates, phenolates, bisphenolates, thiolates, bisthiolates or of azo, azomethine or formazan dyes, e.g. ®Irgalan Bordeaux EL (Ciba Spezialitätenchemie AG) or similar compounds, hindered phenols and derivatives thereof (where appropriate also as anions X⁻), e.g. ®Cibafast AO (Ciba Spezlalitätenchemle AG), hydroxyphenyl-triazoles, -triazines or other UV absorbers, e.g. ®Cibafast W or ®Cibafast P (Ciba Spezialitätenchemie AG) or hindered amines (TEMPO or HALS, also in the form of nitroxides or NOR-HALS, where appropriate also as anions X⁻). Many such structures are known, some of them also in connection with optical recording media, for example from U.S. Pat. No. 5,219,707, JP-A-06/199045, JP-A-07176169 or JP-A-07/262604.

The recording medium according to the invention, in addition to comprising the compounds of formula (I), may additionally comprise salts, for example ammonium chloride, pentadecylammonium chloride, sodium chloride, sodium sulfate, sodium methyl sulfonate or sodium methyl sulfate, the ions of which may originate, for example, from the components used. The additional salts, if present, may be present preferably in amounts of up to 20% by weight, based on the total weight of the recording layer.

Reflecting materials suitable for the reflective layer include especially metals, which provide good reflection of the laser radiation used for recording and playback, for example the metals of Main Groups III, IV and V and of the Sub-Groups of the Periodic Table of the Elements. Al, In, Sn, Pb, Sb, Bi, Cu, Ag, Au, Zn, Cd, Hg, Sc, Y, La, Ti, Zr, Hf, V, Nb, Ta, Cr, Mo, W, Fe, Co, Ni, Ru, Rh, Pd, Os, Ir, Pt, Ce, Pr, Nd, Pm, Sm, Eu, Gd, Th, Dy, Ho, Er, Tm, Yb and Lu, and alloys thereof are especially suitable. Special preference is given to a reflective layer of aluminum, silver, copper, gold or an alloy thereof, on account of their high reflectivity and ease of production.

Materials suitable for the protective layer include chiefly plastics, which are applied in a thin layer to the support or to the uppermost layer either directly or with the aid of adhesive layers. It is advantageous to select mechanically and thermally stable plastics having good surface properties, which may be modified further, for example written. The plastics may be thermosetting plastics or thermoplastic plastics. Preference is given to radiation-curable (for example by means of UV radiation) protective layers, which are particularly simple and economical to produce. A wide variety of radiation-curable materials are known. Examples of radiation-curable monomers and oligomers are acrylates and methacrylates of diols, triols and tetrols, polyimides of aromatic tetracarboxylic acids and aromatic diamines having C₁-C₄alkyl groups in at least two ortho-positions to the amino groups, and oligomers with dialkylmaleimidyl groups, e.g. dimethylmaleimidyl groups.

The recording media according to the invention may have additional layers, for example interference layers. It is also possible to construct recording media having a plurality of (for example two) recording layers. The structure and the use of such materials are known to the person skilled in the art. Preference is given to interference layers that are arranged between the recording layer and the reflecting layer and/or between the recording layer and the substrate and consist of a dielectric material, for example as described in EP-A-353 393 of TiO₂, Si₃N₄, ZnS or silicone resins.

The recording media according to the invention can be produced by processes known per se, it being possible for various methods of coating to be employed depending upon the materials used and their function.

Suitable coating methods are, for example, immersion, pouring, brush-coating, blade-application and spin-coating, as well as vapour-deposition methods carried out under a high vacuum. When, for example, pouring methods are used, solutions in organic solvents are generally employed. Suitable coating methods and solvents are described, for example, in EP-A-401 791.

The recording layer is applied preferably by spin-coating with a dye solution, solvents that have proved satisfactory being especially alcohols, such as, for example, 2-methoxyethanol, n-propanol, isopropanol, isobutanol, n-butanol, amyl alcohol or 3-methyl-1-butanol and mixtures thereof. Ethers (dibutyl ether), ketones (2,6-dimethyl-4-heptanone, 5-methyl-2-hexanone) or saturated or unsaturated hydrocarbons (toluene, xylene) can also be used, for example in the form of mixtures (e.g. dibutyl ether/2,6-dimethylheptanone) or mixed components.

The invention therefore relates also to a method of producing an optical recording medium, wherein a solution of a compound of formula (I) in an organic solvent, especially a non-halogenated organic solvent is applied to a substrate having depressions. The application is preferably carried out by spin-coating.

The application of the metallic reflective layer is preferably effected by sputtering, vapour-deposition in vacuo or by chemical vapour deposition (CVD). The sputtering technique is especially preferred for the application of the metallic reflective layer on account of the high degree of adhesion to the support. Such techniques are known and are described in specialist literature (e.g. J. L. Vossen and W. Kern, “Thin Film Processes”, Academic Press, 1978).

The structure of the recording medium according to the invention is governed primarily by the readout method; known function principles include the measurement of the change in transmission or, preferably, reflection, but it is also known to measure the fluorescence instead of the transmission or reflection.

When the recording medium operates on the basis of a change in reflection, the recording medium may be structured, for example, as follows: transparent support/recording layer (optionally multilayered)/reflective layer and, if expedient, protective layer (not necessarily transparent); or support (not necessarily transparent)/reflective layer/recording layer and, if expedient, transparent protective layer. In the first case, the light is incident from the support side, whereas in the latter case the radiation is incident from the recording layer side or, where applicable, from the protective layer side. In both cases the light detector is located on the same side as the light source. The first-mentioned structure of the recording medium is generally preferred for DVD-R, the latter-mentioned structure (inverse structure) is desirable especially for recording systems in the blue-violet range (DVR; EP-A-822 546 and EP-A-1 103 962).

When the recording medium operates on the principle of a change in light transmission, the following structure, for example, comes into consideration: transparent support/recording layer (optionally multilayered) and, if expedient, transparent protective layer. The light for recording and for readout can be incident either from the support side or from the recording layer side or, where applicable, from the protective layer side, the light detector in this case always being located on the opposite side.

Suitable lasers are those having a wavelength of 600-700 nm, for example commercially available lasers having a wavelength of 602, 612, 633, 635, 647, 650, 658, 670 or 680 nm, especially semiconductor lasers, such as GaAsAl, InGaAlP or GaAs laser diodes having a wavelength especially of about 635, 650 or 658 nm. The recording is generally effected point for point, by modulating the laser in accordance with the mark lengths and focusing its radiation onto the recording layer.

The method according to the invention allows the storage of information with great reliability and stability, distinguished by very good mechanical and thermal stability and by high light-stability and by sharp boundary zones of the pits. Special advantages include the high contrast, the low jitter and the surprisingly high signal/noise ratio, so that problem-free readout is achieved.

The readout of information is carried out according to methods known per so by registering the change in absorption or reflection using laser radiation, for example as described in “CD-Player und R-DAT Recorder” (Claus Biaesch-Wiepke, Vogel Buchverlag, Würzburg 1992).

The information-containing medium according to the invention is especially an optical information material of the WORM type. It can be used, for example, as a playable DVD (digital versatile disk), as storage material for a computer or as an identification and security card or for the production of diffractive optical elements, for example holograms.

The invention accordingly relates also to a method for the optical recording, storage and playback of information, wherein a recording medium according to the invention is used. The recording and the playback advantageously take place in a wavelength range of from 600 to 700 nm.

The compositions according to the invention are, moreover, suitable for the production of printing inks having excellent application properties for various uses such as intaglio/flexo-graphic printing, sheet offset printing and sheet-metal printing, and for the production of colour filters that have an advantageously narrow absorption curve. The invention accordingly relates also to a printing ink or colour filter (optical filter) comprising a composition according to the invention, wherein oxonols are particularly preferred. The invention relates especially to an optical filter comprising a support layer and a filter layer, wherein the filter layer comprises a composition according to the invention. The optical filters can themselves be used for example in electroptical systems such as TV screens, liquid crystal displays, charge coupled devices, plasma displays or electraluminescent displays and the like.

The filter layer contains from 1 to 75% by weight, preferably from 5 to 50% by weight, most preferably from 25 to 40% by weight, of the composition according to the invention, based on the total weight of the filter layer, dispersed in a high-molecular-weight organic material.

The support layer is preferably substantially colourless (T≧95% in the entire visible range from 400 to 700 nm). Further details relating to the production of colour filters and the high molecular-weight materials used in the production of colour filters are described, for example, in High-Technology Applications of Organic Colorants, Peter Gregory, Plenum Press, New York and London 1991, p. 15 to 25, WO01/04215 and WO02/10288. Optical filters having an absorption maximum in the range from 560 to 620 nm are, for example, suitable as very-narrow-band optical filters for plasma displays (see, for example, EP-A-1 124 144).

The printing inks of the invention contain the compositions of the invention judiciously in a concentration of from 0.01 to 40% by weight, preferably from 1 to 25% by weight, with particular preference from 5 to 10% by weight, based on the overall weight of the printing ink, and may be used, for example, for gravure printing, flexographic printing, screen printing, offset printing, or continuous or dropwise inkjet printing on paper, board, metal, wood, leather, plastic or textiles, or else in special applications in accordance with formulations which are general knowledge, for example in publishing, packaging or freight, in logistics, in advertising, in security printing or else in the office sector for ballpoint pens, felt-tip pens, fibre-tip pens, inking pads, ink ribbons or inkjet printer cartridges.

The Examples that follow illustrate the invention. Unless otherwise indicated, figures in percent and in parts are percent by weight and parts by weight, respectively.

### EXAMPLES

### Example 1

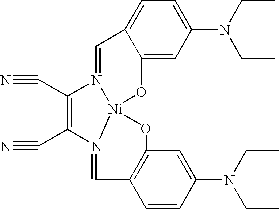

The metal complex is prepared according to Lacroix et al., Chem. Mater. 8 (1996). 541 to 545.

A solution of diaminomaleonitrile (5.41 g, 50 mmol), nickel (II)chloride (11.89 g, 50 mmol) and absolute ethanol (950 ml) is stirred at 70-72° C. A solution of 4-diethylamino-I-salicaldehyde (19.33 g, 100 mmol) in hot ethanol (575 ml) is added during 1 hour, upon which a crystalline precipitate gradually forms. Heating is continued for a further 1 hour, then the mixture is left to cool to 25° C. during 4 hours. The precipitate is filtered off, washed with ethanol and then dried in vacuo at 60° C. Yield 25.3 g (98%).

### Application Example:

1 % by weight of the compound of example 1 is dissolved in chloroform and filtered through a 0.2 μm teflon filter. The dye solution is then applied onto a 1.2 mm thick flat glass substrate (diameter 120 mm) at 250 revs/min and spin coating is subsequently carried out at 600 revs/min. A uniform solid layer is obtained which, after drying 15 minutes at 70° C., has an absorbance of 0.30 at λₘₐₓ 594 nm. The refractive index n and the extinction coefficient k of the so-formed layer are determined by using an optical measurement system (ETA-RT, ETA-Optik). The values at 658 nm are: n(658 nm)=2.33, k(658 nm)=0.084.

1. A metal complex of the following formula 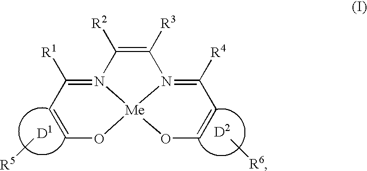
Me is a transition metal of Sub-Group 7, 8, 9, 10, 11 or 12,
D¹ and D² are each independently of the other a carbocyclic or heterocyclic ring or ring system, which may be unsubstituted or substituted by one or more groups R⁵ and R⁶,
R¹ and R⁴ are each independently of the other a hydrogen atom, a perfluoroalkyl radical, an unsubstituted or substituted alkyl radical, an aryl radical or an aralkyl radical,
R² and R³ are a cyano group, or
R² and R³ together form a five to seven membered heterocyclic ring, or
R² and R³ together form an aromatic carbocyclic ring, which is substituted by at least one electron accepting substituent, or which is substituted by at least one electron donating substituent,
R⁵ and R⁶ being a halogen atom, such as fluorine, chlorine or bromine, a group —NR⁸R⁹, a group —SO₂NR⁸R⁹, wherein
R⁸ and R⁹ are each independently of the other a hydrogen atom, an alkyl group, a C₁-C₂₄alkylcarbonyl group, an alkyl group which is substituted by E and/or interrupted by D, a C₆₋₂₄aryl-carbonyl radical or C₇₋₂₄aralkyl-carbonyl radical, an aryl group, or an aralkyl group, or R⁸ and R⁹ together form a five- to seven-membered heterocyclic ring, which optionally can be interrupted by D,
a nitro group, a cyano group, a hydroxy group, an alkyl group, an alkyl group which is substituted by E and/or interrupted by D, an alkoxy group which is substituted by E and/or interrupted by D, an aryloxy group, an aralkyloxy group, an alkylthio group which is substituted by E and/or interrupted by D, an arylthio group, an aralkylthio group, an acyl radical, a phenyl group, an ester group,
a carboxamide group, a sulfamide group, an ammonium group, a carboxylic acid, sulfonic acid, phosphonic acid or phosphoric acid group or a salt thereof,
wherein at least one of the substituents R⁵ and at least one of the substituents R⁶ is an electron donating group, if R² and R³ together form an aromatic carbocyclic ring, which is substituted by at least one electron accepting substituent,
or at least one of the substituents R⁵ and at least one of the substituents R⁶ is an electron accepting group, if R² and R³ together form an aromatic carbocyclic ring, which is substituted by at least one electron donating substituent, wherein
D is —CO—; —S—; —SO—; —SO₂—; —O—; —NR¹⁰; and
E is —OR¹¹; —SR¹¹; —NR¹²R¹³; —COR¹⁴; —COOR¹⁵; —CONR¹²R¹³; —CN; or halogen; wherein
R¹⁰, R¹² and R¹³ are each independently of the other a hydrogen atom, an alkyl group, an aryl group, or an aralkyl group,
R¹¹ is a hydrogen atom, an alkyl group, an aryl group, or an aralkyl group,
R¹⁴ is an alkyl group, an aryl group, or an aralkyl group, and
R¹⁵ is a hydrogen atom, an alkyl group, an aryl group, or an aralkyl group, with the proviso that the following compounds are excluded:

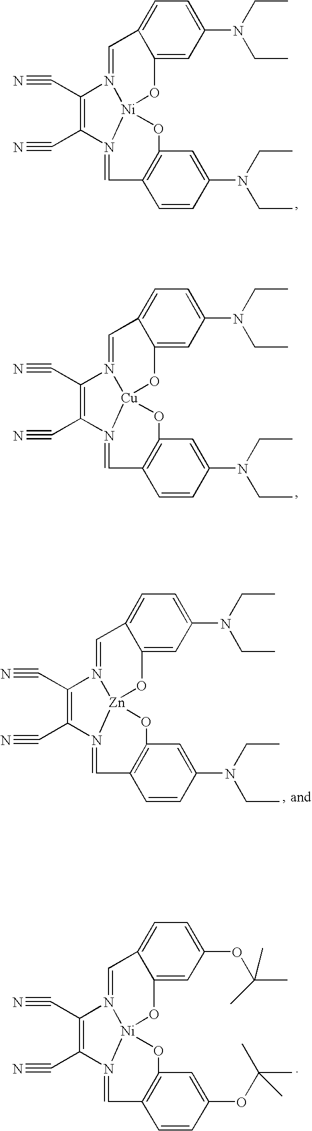

2. A metal complex according to claim 1, having the following formula 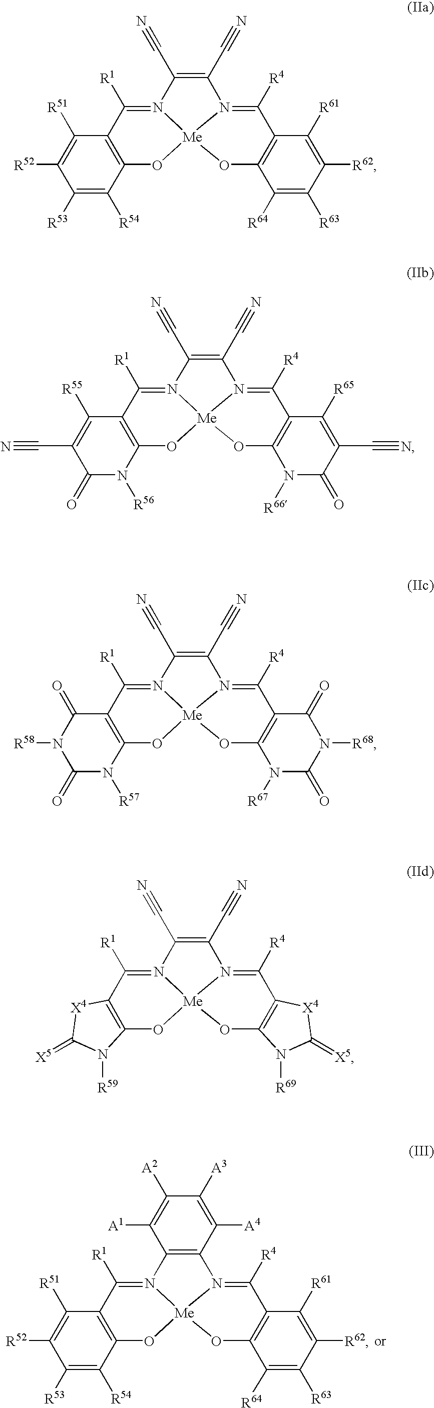 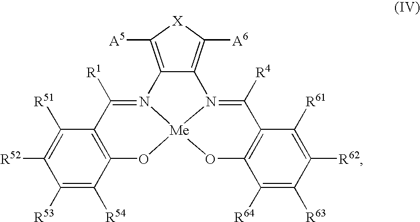
wherein
Me is Co³, Cu²⁺, Ni²⁺, Pd²⁺, Pt²⁺, Co²⁺, or Zn²⁺,
X is >O, >S, >S═O, or >SO₂,
A¹, A⁴, A⁵ and A⁶ are each independently of the other a hydrogen atom, an alkoxy radical, an alkyl radical, an alkyl radical which is interrupted one or more times by —O— or by —S—,
at least one of A² and A³, is an electron accepting substituent, and the other is a hydrogen atom,
R¹ and R⁴are defined as in claim 1,
R⁵¹, R⁵², R⁵⁴, R⁶¹, R⁶² and R⁶⁴ are each independently of the other a hydrogen atom, or an C₁-C₁₈alkyl group,
R⁵³ and R⁶³ are each independently of the other a hydroxy group, an C₁-C₁₈alkoxy group, an C₆-C₂₄aryloxy group, an C₇-C₂₄aralkyloxy group, a group —NR⁸R⁹ or a salt thereof, wherein R⁸ and R⁹ are each independently of the other a hydrogen atom, an C₁-C₁₈alkyl group, an C₁-C₁₈alkyl group which is substituted by E and/or interrupted by D, an C₆-C₂₄aryl group, or an C₇-C₂₄aralkyl group, wherein D and E are as defined in claim 1,
or
R⁵³ and R⁵² R⁵³ and R⁵⁴, R⁶³ and R⁶² and/or R⁶³ and R⁶⁴ are each independently of the other 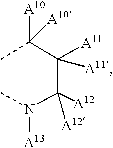
wherein A¹⁰, A^{10′}, A¹¹, A^{11′}, A¹² and A^{12′} are each independently of the other a hydrogen atom, or a C₁-C₈alkyl group,
or
A^{10′} and A^{11′} together, form a double bond, and A¹³ is a hydrogen atom or a C₁-C₈alkyl group,
or
R⁵³ and R⁵² and R⁵⁴, and/or R⁶³ and R⁶² and R⁶⁴ are 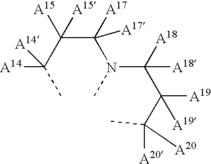
wherein A¹⁴, A^{14′}, A¹⁵, A^{15′}, A¹⁷, A^{17′}, A¹⁸, A^{18′}, A¹⁹, A^{19′}, A²⁰ and A^{20′} are each independently of the other a hydrogen atom, or a C₁-C₈alkyl group,
R⁵⁵ and R⁶⁵ are each independently of the other a hydrogen atom, or a C₁-C₁₈alkyl group,
R⁵⁶, R⁵⁷, R⁵⁸, R⁵⁹, R⁶⁶, R⁶⁷, R⁶⁸ and R⁶⁹ are each independently of the other a hydrogen atom, a C₁-C₁₈alkyl group, or a C₁-C₁₈alkyl group, which is interrupted by one or more oxygen atoms, and
X⁴ and X⁵ are each independently of the other a sulfur, or oxygen atom.

3. A metal complex according to claim 2 having the formula II, III, or IV, wherein
Me is Co³⁺, Cu²⁺, Ni²⁺, Pd²⁺, Pt²⁺, Co²⁺, or Zn²⁺,
X is >O, >S, >S═O, or >SO₂,
A¹, A⁴, A⁵ and A⁶ are a hydrogen atom,
A² and A³ are —NO₂,
R¹ and R⁴ are each independently of the other a hydrogen atom, a perfluoroC₁-C₈alkyl radical or a C₁-C₈alkyl radical,
R⁵¹, R⁵², R⁵⁴, R⁶¹, R⁶² and R⁶⁴are a hydrogen atom,
or
R⁵¹ and R⁵² together, and/or R⁶¹ and R⁶² together, form an unsubstituted or substituted phenyl ring,
R⁵³ and R⁶³ are each independently of the other a hydroxy group, an C₁-C₁₈alkoxy group, a group —NR⁸R⁹, wherein R⁸ and R⁹ are each independently of the other a hydrogen atom, an C₁-C₁₈alkyl group, a group —(CH₂)ₙ—OH, a group —(CH₂CH₂O)ₙ—R¹⁶, where n is a number from the range 1-9 and R¹⁶ is H or C₁-C₁₀alkyl, or a salt thereof,
or
R⁵³ and R⁵², R⁵³ and R⁵⁴, R⁶³ and R⁶² and/or R⁶³ and R⁶⁴ are each independently of the other 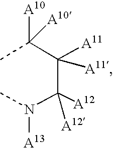
wherein A¹⁰, A^{10′}, A¹¹, A^{11′}, A¹² and A^{12′} are each independently of the other a hydrogen atom, or a C₁-C₈alkyl group,
or
A^{10′} and A^{11′} together, form a double bond, A¹³ is a hydrogen atom or a C₁-C₈alkyl group,
or
R⁵³ and R⁵² and R⁵⁴, and/or R⁶³ and R⁶² and R⁶⁴ are 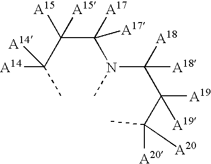
wherein A¹⁴, A^{14′}, A¹⁵, A^{15′}, A¹⁷, A^{17′}, A¹⁸, A^{18′}, A¹⁹, A^{19′}, A²⁰ and A^{20′} are each independently of the other a hydrogen atom, or a C₁-C₈alkyl group.

4. A metal complex according to claim 3, having the formula 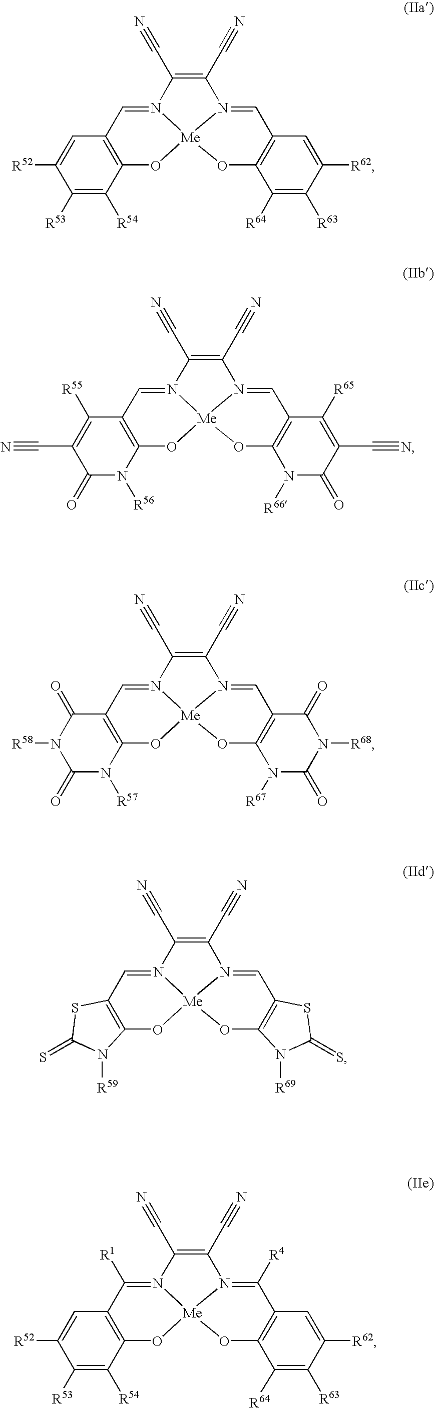 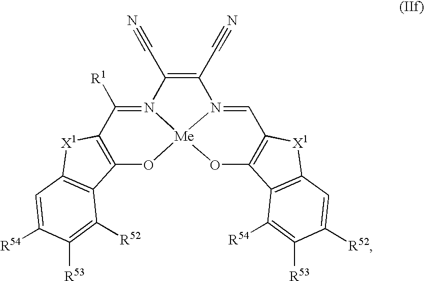
wherein X¹ is a group —O—, —S—, or —NR²⁰⁰—, wherein R²⁰⁰ is a hydrogen atom, or an alkyl group,
R⁵⁵ and R⁶⁵ are each independently of the other a hydrogen atom, or a C₁-C₁₈alkyl group,
R⁵⁶ , R⁵⁷, R⁵⁸, R⁵⁹ , R⁶⁶, R⁶⁷ , R⁶⁸ and R⁶⁹ are each independently of the other a hydrogen atom, a C₁-C₁₈alkyl group, or a C₁-C₁₈alkyl group, which is interrupted by one or more oxygen atoms, 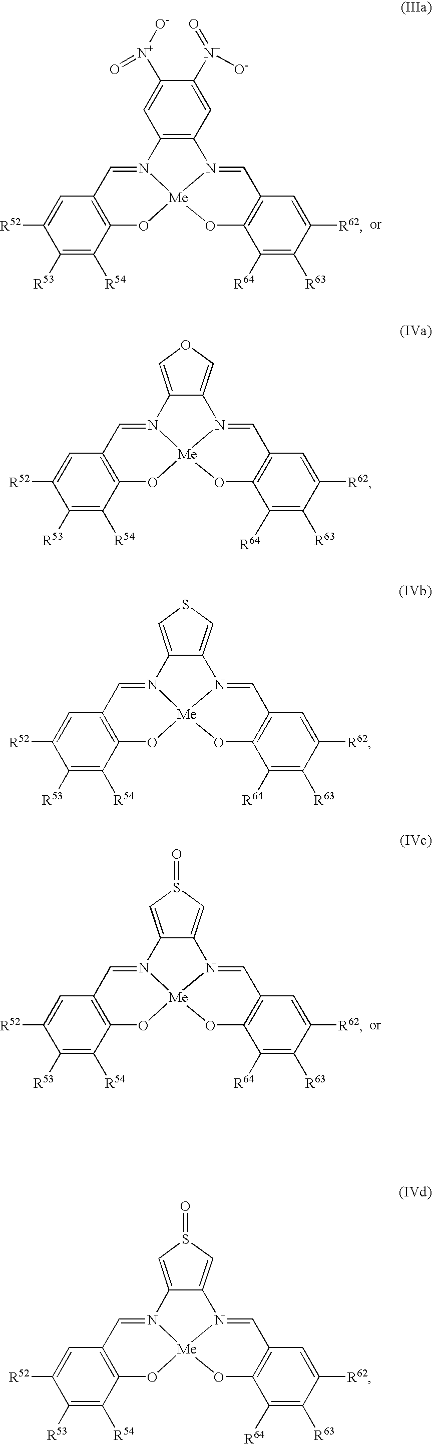
wherein
Me is Co³⁺, Cu²⁺, Ni²⁺, Pd²⁺, Pt²⁺, Co²⁺, or Zn²⁺,
R¹ is hydrogen and R⁴ is C₁-C₄perfluoroalkyl,
R⁵², R⁵⁴, R⁶² and R⁶⁴ are a hydrogen atom,
or
R⁵³ and R⁶³ are each independently of the other a hydroxy group, an C₁-C₁₈alkoxy group, a group —NR⁸R⁹, wherein R⁸ and R⁹ are each independently of the other a hydrogen atom, an C₁-C₁₈alkyl group, a group —(CH₂)ₙ—OH, a group (CH₂CH₂O)ₙ—R¹⁶, where n is a number from the range 1-9 and R¹⁶ is H or C₁-C₁₀alkyl, or a salt thereof,
or
R⁵³ and R⁵², R⁵³ and R⁵⁴, R⁶³ and R⁶², and/or R⁶³ and R⁶⁴ are each independently of the other a group of formula 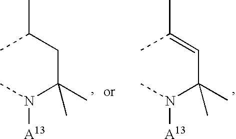
wherein
A¹³ a hydrogen atom or a C₁-C₈alkyl group, or R⁵³ and R⁵² and R⁵⁴, and/or R⁶³ and R⁶² and R⁶⁴ are a group of formula

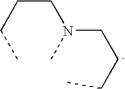

5. A metal complex according to claim 4 of the following structure:

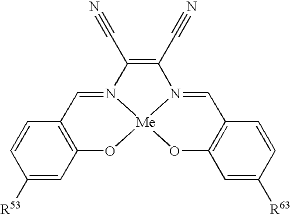

| Compound | R⁵³ = R⁶³ | Me |
|---|---|---|
| A-1 | —N(CH₂)₂OH | Ni²⁺ |
| A-2 | —N(CH₂)₂OH | Cu²⁺ |
| A-3 | —N(CH₂)₂OH | Co²⁺ |
| A-4 | —OH | Ni²⁺ |
| A-5 | —OH | Cu²⁺ |
| A-6 | —OH | Co²⁺ |
| A-7 | —ONa | Ni²⁺ |
| A-8 | —ONa | Cu²⁺ |
| A-9 | —ONa | Co²⁺ |

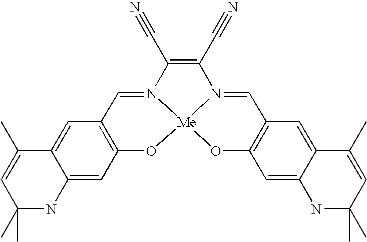

A-10 (Me = Ni²⁺)
A-11 (Me = Cu²⁺)
A-12 (Me = Co²⁺) 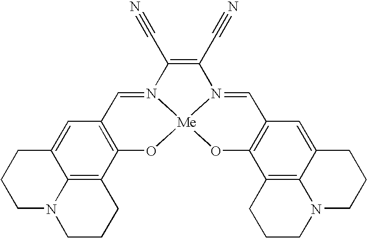
A-13 (Me = Ni²⁺)
A-14 (Me = Cu²⁺)
A-15 (Me = Co²⁺) 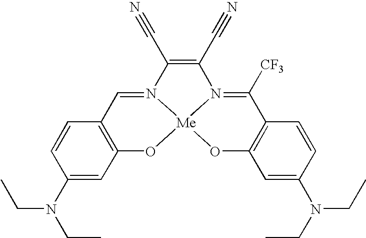
A-16 (Me = Ni²⁺)
A-17 (Me = Cu²⁺)
A-18 (Me = Co²⁺) 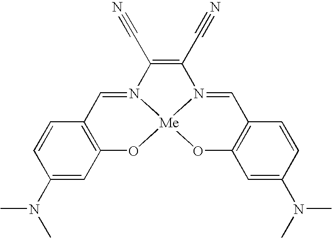
A-19 (Me = Ni²⁺)
A-20 (Me = Cu²⁺)
A-21 (Me = Co²⁺) 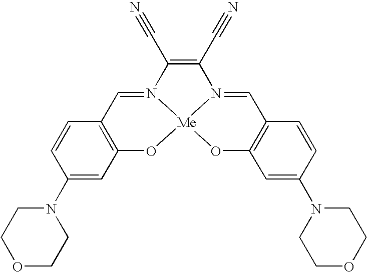
A-22 (Me = Ni²⁺)
A-23 (Me = Cu²⁺)
A-24 (Me = Co²⁺) 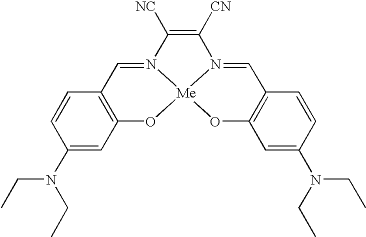
A-25 (Me = Cu²⁺)
A-26 (Me = Co²⁺) 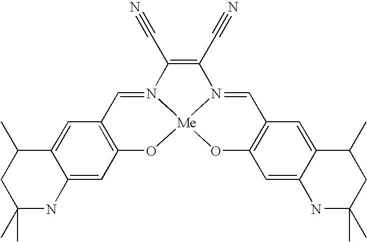
A-27 (Me = Ni²⁺)
A-28 (Me = Cu²⁺)
A-29 (Me = Co²⁺)

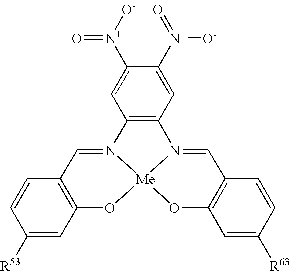

| Compound | R⁵³ = R⁶³ | Me |
|---|---|---|
| B-1 | —N(CH₂)₂OH | Ni²⁺ |
| B-2 | —N(CH₂)₂OH | Cu²⁺ |
| B-3 | —N(CH₂)₂OH | Co²⁺ |
| B-4 | —OH | Ni²⁺ |
| B-5 | —OH | Cu²⁺ |
| B-6 | —OH | Co²⁺ |
| B-7 | —ONa | Ni²⁺ |
| B-8 | —ONa | Cu²⁺ |
| B-9 | —ONa | Co²⁺ |
| B-10 | —ONH₄ | Ni²⁺ |
| B-11 | —ONH₄ | Cu²⁺ |
| B-12 | —ONH₄ | Co²⁺ |

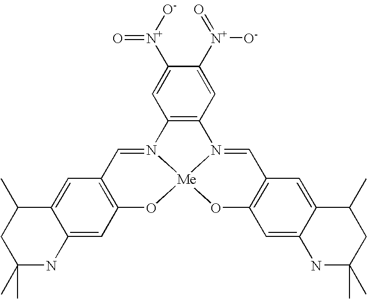

B-13 (Me = Ni²⁺)
B-14 (Me = Cu²⁺)
B-15 (Me = Co²⁺) 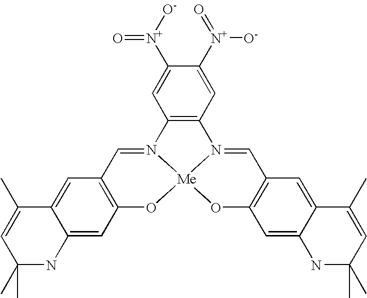
B-16 (Me = Ni²⁺)
B-17 (Me = Cu²⁺)
B-18 (Me = Co²⁺) 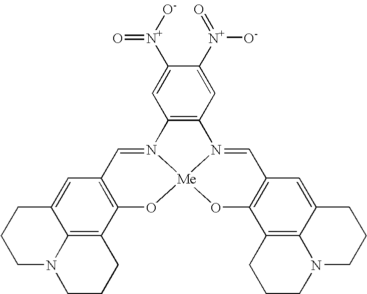
B-19 (Me = Ni²⁺)
B-20 (Me = Cu²⁺)
B-21 (Me = Co²⁺)

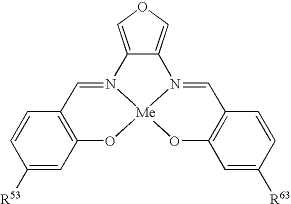

| Compound | R⁵³ = R⁶³ | Me |
|---|---|---|
| C-1 | —N(CH₂)₂OH | Ni²⁺ |
| C-2 | —N(CH₂)₂OH | Cu²⁺ |
| C-3 | —N(CH₂)₂OH | Co²⁺ |
| C-4 | —OH | Ni²⁺ |
| C-5 | —OH | Cu²⁺ |
| C-6 | —OH | Co²⁺ |

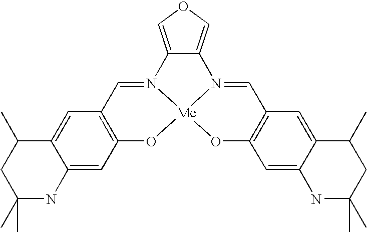

C-7 (Me = Ni²⁺)
C-8 (Me = Cu²⁺)
C-9 (Me = Co²⁺) 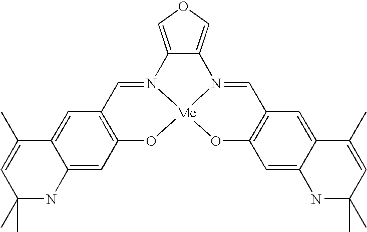
C-10 (Me = Ni²⁺)
C-11 (Me = Cu²⁺)
C-12 (Me = Co²⁺) 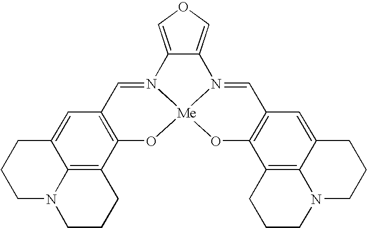
C-13 (Me = Ni²⁺)
C-14 (Me = Cu²⁺)
C-15 (Me = Co²⁺)

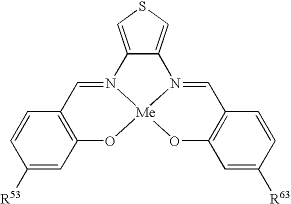

| Compound | R⁵³ = R⁶³ | Me |
|---|---|---|
| D-1 | —N(CH₂)₂OH | Ni²⁺ |
| D-2 | —N(CH₂)₂OH | Cu²⁺ |
| C-3 | —N(CH₂)₂OH | Co²⁺ |
| D-4 | —OH | Ni²⁺ |
| D-5 | —OH | Cu²⁺ |
| D-6 | —OH | Co²⁺ |

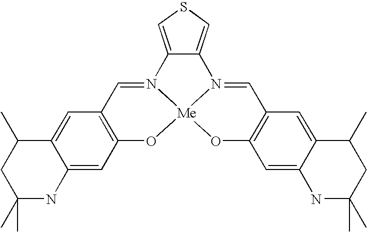

D-7 (Me = Ni²⁺)
D-8 (Me = Cu²⁺)
D-9 (Me = Co²⁺) 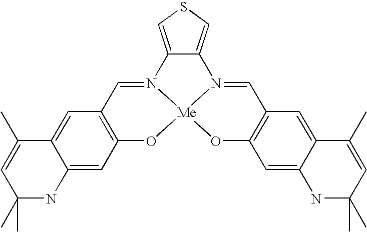
D-10 (Me = Ni²⁺)
D-11 (Me = Cu²⁺)
D-12 (Me = Co²⁺) 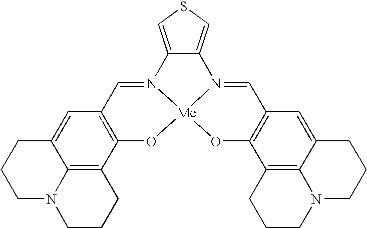
D-13 (Me = Ni²⁺)
D-14 (Me = Cu²⁺)
D-15 (Me = Co²⁺) 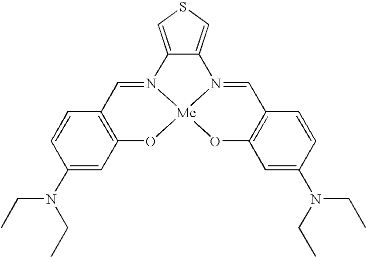
D-16 (Me = Ni²⁺)
D-17 (Me = Cu²⁺)
D-18 (Me = Co²⁺)

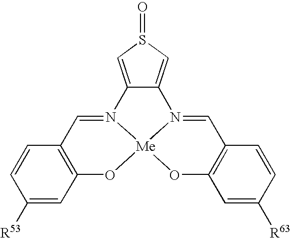

| Compound | R⁵³ = R⁶³ | Me |
|---|---|---|
| E-1 | —N(CH₂)₂OH | Ni²⁺ |
| E-2 | —N(CH₂)₂OH | Cu²⁺ |
| E-3 | —N(CH₂)₂OH | Co²⁺ |
| E-4 | —OH | Ni²⁺ |
| E-5 | —OH | Cu²⁺ |
| E-6 | —OH | Co²⁺ |

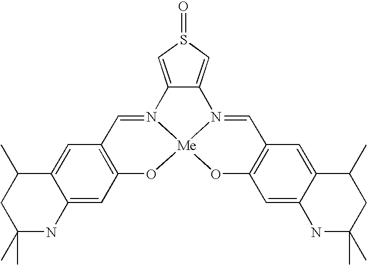

E-7 (Me = Ni²⁺)
E-8 (Me = Cu²⁺)
E-9 (Me = Co²⁺) 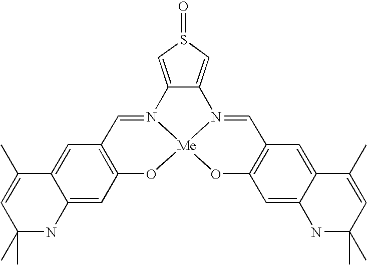
E-10 (Me = Ni²⁺)
E-11 (Me = Cu²⁺)
E-12 (Me = Co²⁺) 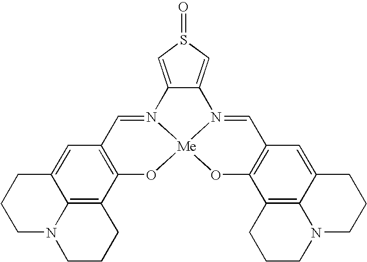
E-13 (Me = Ni²⁺)
E-14 (Me = Cu²⁺)
E-15 (Me = Co²⁺)

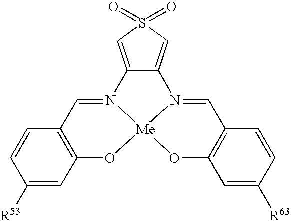

| Compound | R⁵³ = R⁶³ | Me |
|---|---|---|
| F-1 | —N(CH₂)₂OH | Ni²⁺ |
| F-2 | —N(CH₂)₂OH | Cu²⁺ |
| F-3 | —N(CH₂)₂OH | Co²⁺ |
| F-4 | —OH | Ni²⁺ |
| F-5 | —OH | Cu²⁺ |
| F-6 | —OH | Co²⁺ |

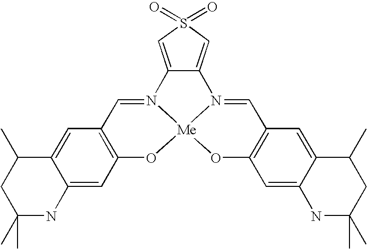

F-7 (Me = Ni²⁺)
F-8 (Me = Cu²⁺)
F-9 (Me = Co²⁺) 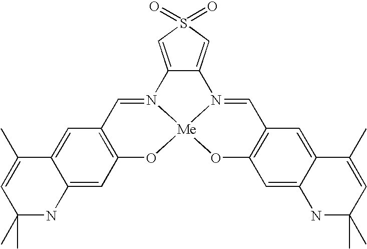
F-10 (Me = Ni²⁺)
F-11 (Me = Cu²⁺)
F-12 (Me = Co²⁺) 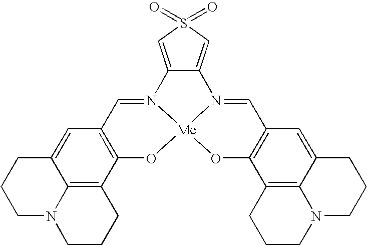
F-13 (Me = Ni²⁺)
F-14 (Me = Cu²⁺)
F-15 (Me = Co²⁺)

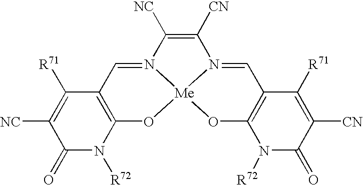

| Compound | R⁷¹ | R⁷² | Me |
|---|---|---|---|
| G-1 | —CH₃ | —CH₃ | Ni²⁺ |
| G-2 | —CH₃ | —CH₃ | Cu²⁺ |
| G-3 | —CH₃ | —CH₃ | Co²⁺ |
| G-4 | —CH₃ | —(CH₂)₃OCH(CH₃)₂ | Ni²⁺ |
| G-5 | —CH₃ | —(CH₂)₃OCH(CH₃)₂ | Cu²⁺ |
| G-6 | —CH₃ | —(CH₂)₃OCH(CH₃)₂ | Co²⁺ |
| G-7 | —CH₃ | H | Ni²⁺ |
| G-8 | —CH₃ | H | Cu²⁺ |
| G-9 | —CH₃ | H | Co²⁺ |

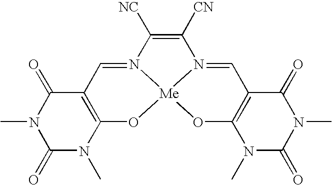

H-1 (Me = Ni²⁺)
H-2 (Me = Cu²⁺)
H-3 (Me = Co²⁺) 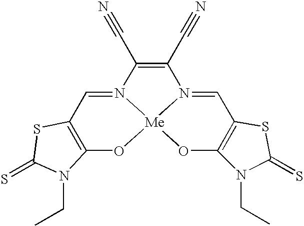
I-1 (Me = Ni²⁺)
I-2 (Me = Cu²⁺) or
I-3 (Me = Co²⁺).

6. A composition, comprising
(a) a metal complex according to claim 1, and
(b) a dye.

7. A composition according to claim 6, wherein
Me in formula I, II, III or IV is Ni²⁺, Cu²⁺, or Co²⁺ and the dye is a oxonol dye of formula 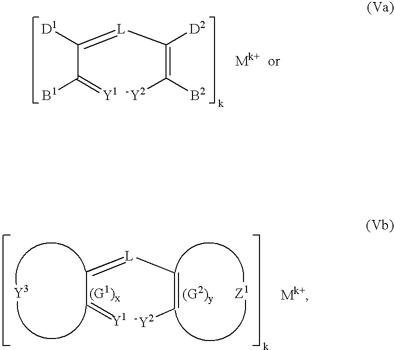
wherein D¹, D², B¹ and B² are in each case a substituent; Y³ and Z¹ are in each case a group of atoms necessary for the formation of a carbocyclic or heterocyclic ring; G¹ and G² are in each case a group of atoms necessary for the formation of a chain having conjugated double bonds;
Y¹ is ═O, ═NR¹⁰⁹ or ═C(CN)₂, R¹⁰⁹ being a substituent; Y² is —O, —NR¹⁰⁹ or —C(CN)₂, R¹⁰⁹ being a substituent; L is a methine group, which may be substituted, or a group by means of which a polymethine group is completed, it being possible for 3, 5 or 7 methine groups to be connected in order to form a chain having conjugated double bonds, which chain may be substituted, x and y are 0 or 1, M^{k+} is an organic or inorganic cation, and k is an integer from 1 to 10

8. An optical recording medium comprising a substrate and at least one recording layer, wherein the recording layer comprises a metal complex according to claim 1.

9. (canceled)

10. A method of producing an optical recording medium, wherein a solution of a metal complex according to claim 1 in a solvent, is applied to a substrate having depressions.

11. A method of producing an optical recording medium according to claim 10, wherein the solvent is a non-halogenated solvent.

12. A metal complex according to claim 1, wherein Me is a transition metal of Sub-Group 9, 10 or 11, when R⁵ or R⁶ is a halogen atom it is fluorine, chlorine or bromine, and when R⁵ or R⁶ is an ester group it is a phosphonic acid, phosphoric acid or carboxylic acid ester group.

13. A metal complex according to claim 2, wherein Me is Cu²⁺.

14. A metal complex according to claim 2, wherein at least one of A² and A³, is an electron accepting substituent selected from —NO₂, chlorine, bromine and a group —SO₂—NR⁸R⁹ and the other is a hydrogen atom

15. A metal complex according to claim 3, wherein Me is Cu²⁺.

16. An optical recording medium comprising a substrate and at least one recording layer, wherein the recording layer comprises a composition according to claim 6.

17. A method of producing an optical recording medium, wherein a solution of a composition according to claim 6 in a solvent, is applied to a substrate having depressions.

18. A method of producing an optical recording medium according to claim 17, wherein the solvent is a non-halogenated solvent.

19. A color filter or printing ink comprising a metal complex according to claim 1.

20. A color filter or printing ink comprising a composition according to claim 6.
